(19) United States
(12) Patent Application Publication
(10) Pub. No.: US 2010/0253114 A1
(43) Pub. Date: Oct. 7, 2010

(54) SHOCK ABSORPTION STRUCTURE FOR VEHICLE

(75) Inventors: Hiroyuki OHMIYA, Aichi (JP); Takahiko TANIGUCHI, Aichi (JP)

Correspondence Address: Toshiyuki Yokoi, 13700 Marina Pointe Drive, Unit 723, Marina del Rey, CA, 90292, US

(73) Assignee: HAYASHI ENGINEERING INC., Nagoya-shi (JP)

(21) Appl. No.: 12/823,136

(22) Filed: Jun. 25, 2010

Related U.S. Application Data
(63) Continuation of application No. PCT/JP2009/050736, filed on Jan. 20, 2009.

(30) Foreign Application Priority Data
Jan. 21, 2008 (JP) 2008-010429
Jan. 16, 2009 (JP) 2009-007248

(51) Int. Cl. B60R 21/04

(52) U.S. Cl. 296/187.05

(57) ABSTRACT

The present invention discloses a shock absorption structure for vehicle installed between a vehicle body panel and an interior member that is closer to a passenger compartment side than the vehicle body panel. The shock absorption structure for vehicle includes a plurality of cup-shaped shock absorbing parts and a connecting part. Each of the shock absorbing parts has an open surface on a wide diameter side and a closed surface on a narrow diameter side, and also has a line-shaped induction part that is formed on a side face from an edge on the wide diameter side to a point midway toward an edge on the narrow diameter side and that induces a crack when a shock is applied. The connecting part connects the plurality of shock absorbing parts at the edges on the wide diameter sides.

### CROSS-REFERENCES TO RELATED APPLICATIONS

This Application claims the benefit of priority and is a Continuation application of the prior International Patent Application No. PCT/JP2009/050736, with an international filing date of Jan. 20, 2009, which designated the United States, and is related to the Japanese Patent Application No. 2009-007248, filed Jan. 16, 2009 and the Japanese Patent Application No. 2008-010429, filed Jan. 21, 2008, the entire disclosures of all applications are expressly incorporated by reference in their entirety herein.

### BACKGROUND OF THE INVENTION

1. Field of the Invention

The present invention relates to a shock absorption structure for vehicle installed between a vehicle body panel and an interior member that is closer to a passenger compartment side than the vehicle body panel.

2. Description of Related Art

An interior member is installed on a passenger compartment side of a vehicle body panel composing a body of a motor vehicle. A shock absorption structure for vehicle is arranged between the interior member and the vehicle body panel in a position corresponding to a place where an occupant is highly likely to contact the interior member.

Each of Japanese Patent Application Publication No. JP-A-2007-137288 and Japanese Patent Application Publication No. JP-A-2007-190971 discloses a shock absorbing member for vehicle having a plurality of shock absorbing protrusions in a circular truncated cone shape and a planar connecting part to connect and support edges of the shock absorbing protrusions.

A plurality of rectangular openings are formed on a side face of the shock absorbing member described in JP-A-2007-137288 in order to increase a deformation stroke when a shock is applied. Because of the openings, when the shock absorbing member for vehicle receives the shock, the member is deformed so as to crush the outer peripheral side face.

In the shock absorbing member for vehicle described in JP-A-2007-190971, a plurality of openings are formed on a top face and also on an outer peripheral side face in order to increase a deformation stroke when a shock is applied. Because of the openings on the top face and the side face, when the shock absorbing member receives the shock, the member is deformed so as to crush the top face and the outer peripheral side face.

In the shock absorbing members for vehicle described in JP-A-2007-137288 and JP-A-2007-190971, increasing the deformation stroke when the shock is applied widens the region of displacement in which a load (stress) is maintained at a substantially constant level after being generated in the initial stage of displacement. However, in the case that the occupant hits the interior member at multiple places when a shock occurs on the motor vehicle, the shock absorbing performance like this may not be an optimal shock absorbing performance.

### BRIEF SUMMARY OF THE INVENTION

The present invention discloses a shock absorption structure to improve a shock absorbing performance in the case that an occupant hits an interior member at multiple places when a shock occurs on a motor vehicle.

One aspect of the present invention provides a shock absorption structure for vehicle installed between a vehicle body panel and an interior member that is closer to a passenger compartment side than the vehicle body panel, the shock absorption structure for vehicle comprising:

a plurality of cup-shaped shock absorbing parts, each of which has an open surface on a wide diameter side and a closed surface on a narrow diameter side, and also has a line-shaped induction part that is formed on a side face from an edge on the wide diameter side to a point midway toward an edge on the narrow diameter side and that induces a crack when a shock is applied; and

a connecting part that connects the plurality of shock absorbing parts at the edges on the wide diameter sides.

When a shock is applied to the shock absorption structure, the plurality of shock absorbing parts tend to crack caused by the line-shaped induction parts after generating a load (stress) in the initial stage of displacement. If the plurality of shock absorbing parts crack when the shock is applied, the load decreases after being generated in the initial stage of displacement. As a result, the shock absorbing performance can be improved in the case that the occupant hits the interior member at multiple places when a shock occurs.

Another aspect of the present invention provides a shock absorption structure for vehicle installed between a vehicle body panel and an interior member that is closer to a passenger compartment side than the vehicle body panel, the shock absorption structure for vehicle comprising:

a plurality of cup-shaped first shock absorbing parts, each of which has an open surface on a wide diameter side and a closed surface on a narrow diameter side;

a plurality of second shock absorbing parts, each of which is formed in a cup shape with a different height from that of the first shock absorbing part, has an open surface on the wide diameter side and a closed surface on the narrow diameter side, and also has a line-shaped induction part that is formed on a side face from an edge on the wide diameter side to a point midway toward an edge on the narrow diameter side and that induces a crack when a shock is applied; and

a connecting part that connects the plurality of first shock absorbing parts and the plurality of second shock absorbing parts at the edges on the wide diameter sides.

When a shock is applied to the shock absorption structure, the plurality of second shock absorbing parts tend to crack caused by the line-shaped induction parts after generating a load in the initial stage of displacement. If the plurality of second shock absorbing parts crack when the shock is applied, the load decreases after being generated in the initial stage of displacement. In addition, because the first shock absorbing parts and the second shock absorbing parts have different heights from each other, the first and the second shock absorbing parts differ in timing of the load generation in the initial stage of displacement.

As a result of the above, the shock absorbing performance can be improved in the case that the occupant hits the interior member at multiple places when a shock occurs.

Here, the term “cup shape” used in the present invention includes shapes having an outer shape of a frustum such as an elliptical truncated cone shape (including circular truncated cone shape) or a polygonal truncated pyramid shape. Also, the term “wide diameter side” used in the present invention means the larger area side of both base portions of the frustum shape. Moreover, the term “narrow diameter side” used in the present invention means the smaller area side of the both base portions.

In addition, the term “induction part” used in the present invention includes a slit penetrating a side face of a cup-shaped shock absorbing part, a groove formed on the side face, and a thin-wall part provided of the thinned side face. The term “line-shaped induction part” used in the present invention includes a line-shaped induction part, a curved induction part, and a broken line-shaped induction part. For example, the slit includes a slit of a substantially rectangular shape opened at a predetermined width, a slit opened at a predetermined width in a winding manner, and a slit opened at a changing width.

Furthermore, the connecting part and the plurality of shock absorbing parts may be either integrally provided or assembled after being provided separately.

These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

FIG. 1 is a part cross-sectional view illustrating an example of a part of a motor vehicle in a vertical section parallel to a front-rear direction.

FIG. 2 is a part cross-sectional view illustrating an example of a state in which a shock absorption structure is arranged between a vehicle body panel and an interior member.

FIG. 3 is a perspective view illustrating an example of an external appearance of the shock absorption structure.

FIG. 4A is an exemplary illustration of an end view illustrating an end obtained by breaking the shock absorption structure shown in FIG. 3.

FIG. 4B is an exemplary illustration of an end view illustrating an end obtained by breaking the shock absorption structure shown in FIG. 3.

FIG. 5 is an exemplary illustration of a partial enlarged view showing a portion cut out from the shock absorption structure shown in FIG. 3 so as to include one of shock absorbing parts.

FIG. 6A is an exemplary illustration of a diagram illustrating a load-displacement curve obtained by conducting impact tests using the shock absorption structures.

FIG. 6B is an exemplary illustration of a diagram illustrating load-displacement curves obtained by conducting impact tests using the shock absorption structures.

FIG. 7 is an exemplary illustration of a diagram schematically showing an impact test method.

FIG. 8 is a diagram showing load-displacement curves obtained from impact tests of Examples 1 to 5 and of Comparative Example 3 with varying a slit height h.

FIG. 9 is a diagram showing load-displacement curves obtained from impact tests of Examples 4 and 6 with varying a slit width, and of Comparative Example 1.

FIG. 10 is a diagram showing load-displacement curves obtained from impact tests of Examples 4, 7, 8, and 9 with varying number of slits, and of Comparative Example 1.

FIG. 11 is a diagram showing load-displacement curves obtained from impact tests of Comparative Example 2 and Example 3.

FIG. 12 is a diagram showing load-displacement curves obtained from impact tests of Examples 4, 10, and 11 with different levels of Charpy impact strength.

FIG. 13 shows diagrams for explaining slit shapes of Examples 4, 12, and 13.

FIG. 14 is a diagram showing load-displacement curves obtained from impact tests of Examples 4, 12, and 13.

FIG. 15 is an exemplary illustration of a perspective view illustrating an example of an external appearance of a shock absorption structure according to a second embodiment.

FIG. 16 is an exemplary illustration of a plan view of the shock absorption structure shown in FIG. 15.

FIG. 17 is a part cross-sectional view illustrating an example of a part of the motor vehicle in a vertical section parallel to the front-rear direction.

FIG. 18 is a part cross-sectional view illustrating the example of the part of the motor vehicle in a vertical section parallel to the vehicle width direction.

FIG. 19 is a diagram illustrating an example of a load applied to an occupant dummy head in the motor vehicle shown in FIG. 18.

FIG. 20 is a part cross-sectional view illustrating an example of a part of the motor vehicle in a vertical section parallel to the front-rear direction.

FIG. 21 is a part cross-sectional view illustrating the example of the part of the motor vehicle in a vertical section parallel to the vehicle width direction.

FIG. 22 is a diagram illustrating an example of a load applied to the occupant dummy head in the motor vehicle shown in FIG. 21.

FIG. 23 is an exemplary illustration of a perspective view showing an external appearance of a shock absorption structure according to a modification.

FIG. 24 is a perspective view illustrating an example of an external appearance of a shock absorption structure according to a third embodiment.

FIG. 25 is a part cross-sectional view illustrating an example of the part of the motor vehicle in a vertical section parallel to the front-rear direction.

FIG. 26 is a diagram illustrating an example of a load applied to the occupant dummy head in the motor vehicle shown in FIG. 25.

FIG. 27 is a perspective view illustrating an example of an external appearance of a shock absorption structure according to a fourth embodiment.

FIG. 28 is a diagram illustrating an example of a load applied to the occupant dummy head in the motor vehicle equipped with the shock absorption structure shown in FIG. 27.

FIG. 29 is a perspective view illustrating an example of an external appearance of a shock absorption structure according to a fifth embodiment.

FIG. 30 is a perspective view illustrating an example of an external appearance of a shock absorption structure according to a sixth embodiment.

FIG. 31 is a part cross-sectional view illustrating, in a vertical section parallel to the front-rear direction, an example of a part of the motor vehicle equipped with a shock absorption structure according to a seventh embodiment.

FIG. 32A is an exemplary illustration of a vertical end view for explaining a modification of an induction part.

FIG. 32B is an exemplary illustration of a vertical end view for explaining a modification of an induction part.

FIG. 33A is an exemplary illustration of a diagram illustrating load-displacement curves obtained by conducting impact tests using the shock absorption structures according to the comparative examples.

FIG. 33B is an exemplary illustration of a diagram illustrating load-displacement curves obtained by conducting an impact test using the shock absorption structure according to the comparative examples.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

### (1) First Embodiment

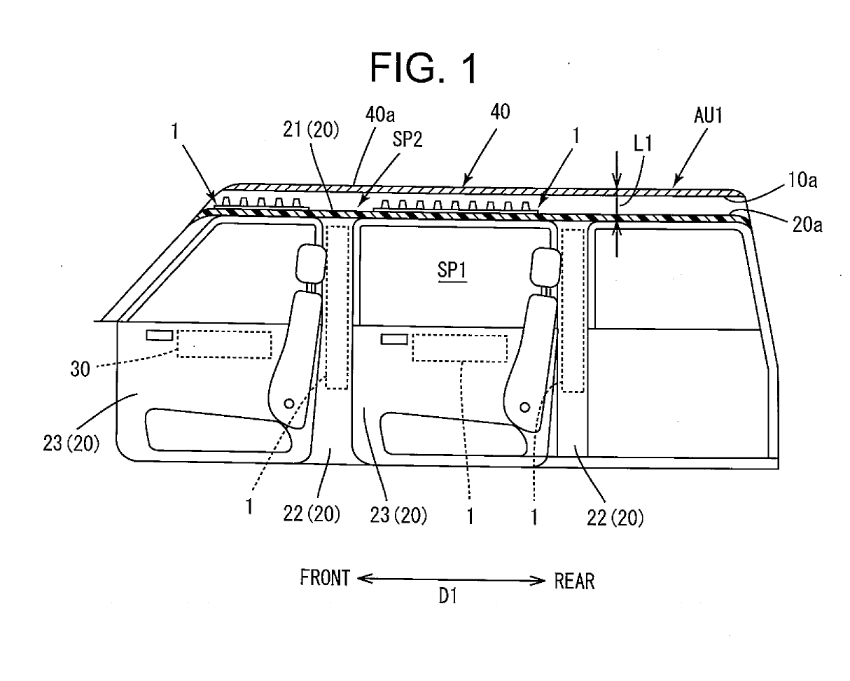

FIG. 1 is an exemplary illustration of a part cross-sectional view showing, in a vertical section parallel to a front-rear direction D1, a part of a road motor vehicle AU1 employing a shock absorption structure 1 for vehicle according to a first embodiment of the present invention. In the passenger motor vehicle AU1 shown in FIG. 1, a vehicle body is structured so that a vehicle body panel 40 is formed by bonding so as to enclose a passenger compartment SP1. In addition, various interior members 20 are installed on the passenger compartment side of the vehicle body panel 40. The shock absorption structure 1 is arranged, for example, in a space SP2 formed between the interior member 20 and the vehicle body panel 40, and mounted and fixed to a back surface 20a (surface toward outside of vehicle) of the interior member 20. The shock absorption structure 1 of the present embodiment is suitable for using in a place with a relatively limited space between the vehicle body panel 40 and the interior members 20.

The vehicle body panel 40 serves as a framework constituting the body of the road motor vehicle AU1. The vehicle body panel 40 is composed of a roof panel 40a forming a roof portion of the vehicle body, pillars supporting the roof panel, door panels forming doors, a floor panel forming a floor portion of the vehicle body, and so on. The vehicle body panel 40 is provided, for example, by pressing steel sheets.

The interior members 20 cover the passenger compartment side of the vehicle body to provide a suitable design feature as interior materials, and also provide such properties as heat insulation and sound absorption. The interior members 20 shown in FIG. 1 are composed of a roof liner interior material 21 provided on the passenger compartment side of the roof panel 40a, a pillar garnish interior material 22 provided on the passenger compartment side of the pillars, a door trim interior material 23 provided on the passenger compartment side of the door panels, and so on.

The interior members 20 are provided, for example, in a manner in which the surface on the passenger compartment side of an interior base material is layered with a skin material. The interior base material uses, for example, material formed by press forming resin molding materials such as a thermoplastic resin, material formed by foaming resin molding materials, material formed by impregnating or applying binder to foamed resin, or material formed by assembling fibers such as thermoplastic resin fibers. The skin material uses, for example, nonwoven fabric, woven fabric, or knitted fabric.

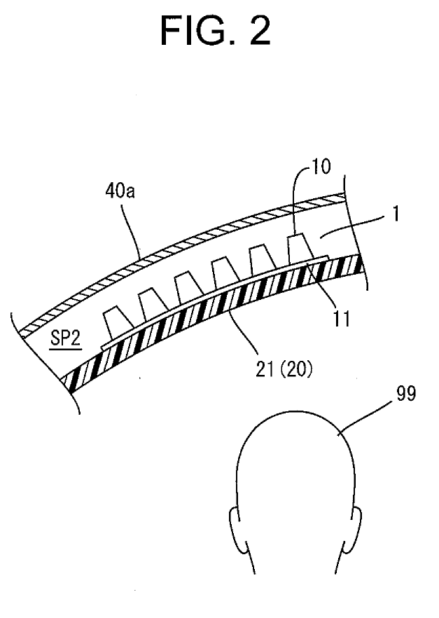

FIG. 2 is an exemplary illustration of a part vertical cross-sectional view schematically showing the shock absorption structure 1 installed between the roof panel 40a and the roof liner interior material 21 in the motor vehicle, along with an occupant 99. The shock absorption structure 1 is fixed on the surface of the roof liner interior material 21 facing the roof panel 40a, with a surface provided with shock absorbing parts 10 (to be described later) facing the roof panel 40a. The shock absorption structure 1 is fixed to the roof liner interior material 21, for example, by applying adhesive agent to the surface of a base (connecting part) 11 opposite to the surface provided with the shock absorbing parts 10 and pasting the shock absorption structure 1 on the roof liner interior material 21.

For the purpose of head protection, the inventors of the present invention arranged various types of the shock absorption structure between the roof panel and the roof liner interior material, and repeated impact tests. It has been found through the tests that the head of an occupant dummy contacts the interior members in multiple stages, for example, in a manner in which the forehead of the occupant dummy first hits the roof liner interior material and then the jaw of the occupant dummy hits the pillar garnish interior material. Particularly, on the back side (outside of vehicle) of the interior members in places where the jaw of the occupant hits, the vehicle body panel may be attached with comparatively hard components such as a deployment guide member for curtain airbag, assist grips, coat hooks, and connecting members for pillar panels and interior members. Here, the deployment guide member is a member for preventing the curtain airbag from being deployed between the pillar garnish interior material and the pillar panel so as to be deployed in the passenger compartment. The deployment guide member may be integrally formed with the pillar garnish interior material. If the vehicle body panel is attached with a component such as the deployment guide member, it is desirable to give sufficient consideration to a load to the occupant head caused by a compressive load of the component when the jaw hits the interior member.

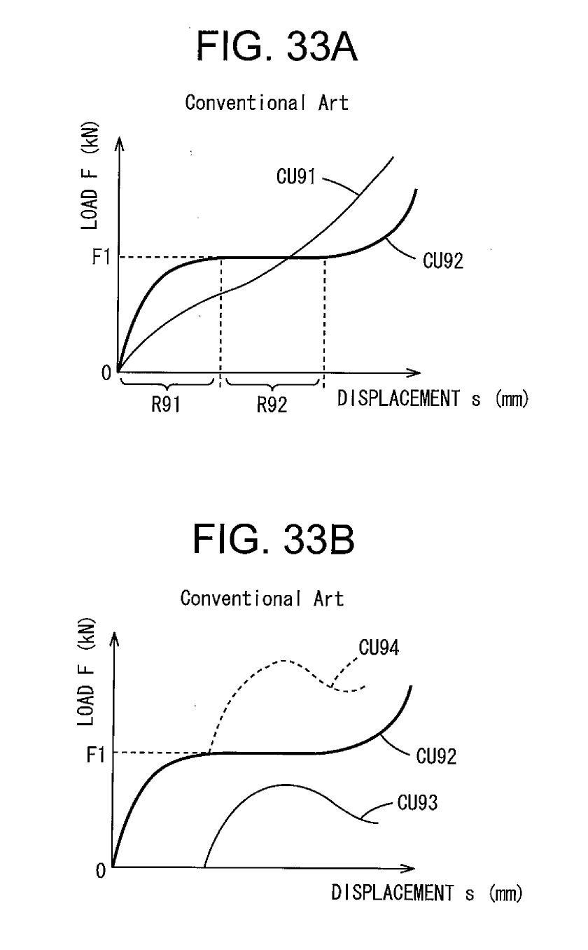

Here, as shown in FIG. 33A, the normal compressive load (stress) F-displacement s curve for a shock absorbing member is a simple upward-sloping curve CU91 or a rectangular waveform curve CU92 having a region R91 of an initial displacement stage and a region R92 of a substantially constant load. Therefore, the shock absorbing member that shows the normal F-s curve maintains a high level of reaction force for the displacement s after generating a compressive load F in the initial stage of displacement.

If the occupant dummy head contacts the interior members in two stages, a compressive load of an F-s curve CU93 generated by the second contact is added to the high-level reaction force in the region R92, as shown in FIG. 33B. If the component such as the deployment guide member is arranged on the back side of the interior member in a position corresponding to the jaw of the occupant, the reaction force by the compressive load of the component is applied to the occupant dummy head. The load applied to the occupant dummy head results in a load of an F-s curve CU94 obtained by combining the F-s curve by the first contact and the F-s curve by the second contact. As a result, in the region R92 appearing after the compressive load is generated in the initial stage of displacement, the load applied to the occupant dummy head may not be optimal, and thus the injury index of the occupant head may not be optimal when a motor vehicle crash test is conducted. The same applies in the case in which the occupant dummy head contacts the interior members in three or more stages.

The inventors of the present invention have studied the shape, the material, and the thickness of the cup-shaped shock absorbing parts, and also analyzed the behavior of the compressive load-displacement curve of the shock absorbing parts. As a result, the inventors of the present invention have found that, by reducing the compressive load of the shock absorbing parts in the process of displacement, the shock applied to the occupant head can be efficiently absorbed without making the reaction force applied to the occupant head excessively large, thus enabling to reduce the injury index of the occupant head.

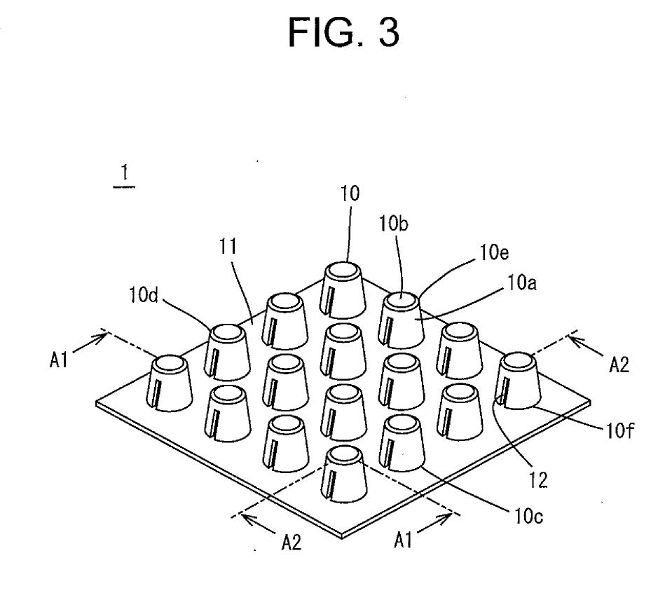

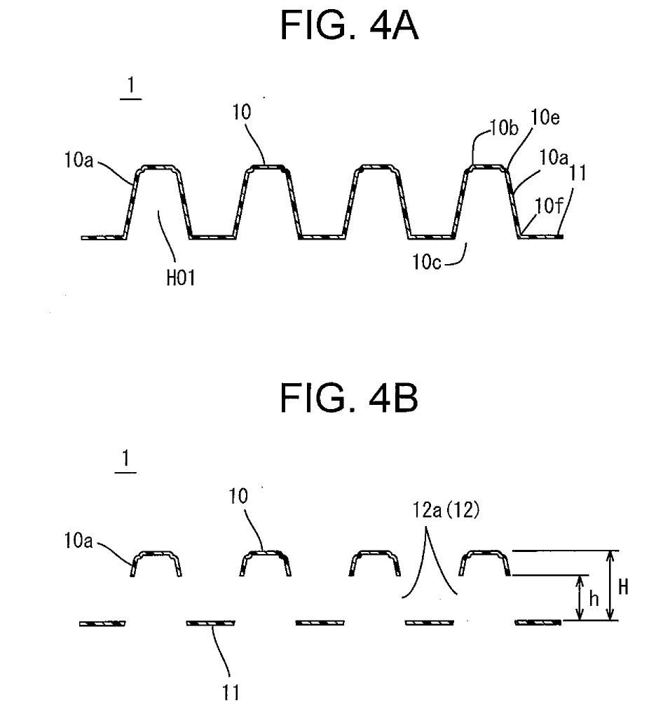

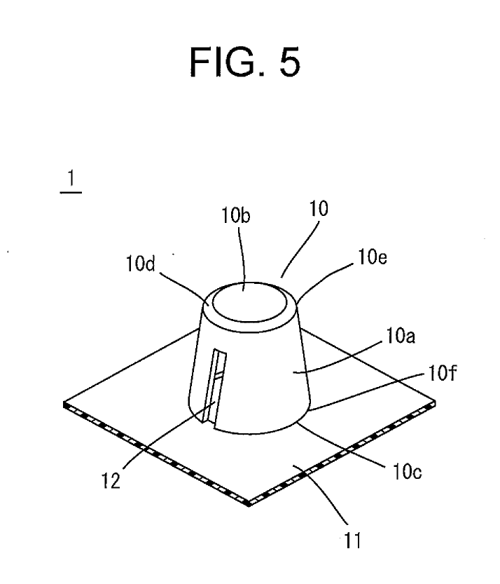

FIG. 3 is a perspective view of the shock absorption structure 1, non-limiting embodiment of the present invention. FIG. 4A is an exemplary illustration of an end view showing an end obtained by breaking the shock absorption structure 1 in the position of A1-A1 shown in FIG. 3. FIG. 4B is an exemplary illustration of an end view showing an end obtained by breaking the shock absorption structure 1 in the position of A2-A2 shown in FIG. 3. FIG. 5 is an exemplary illustration of a partial enlarged view showing a portion cut out from the shock absorption structure 1 so as to include one of the shock absorbing parts 10.

The shock absorption structure 1 has the plurality of cup-shaped shock absorbing parts 10 and the sheet-shaped base (connecting part) 11 integrally provided with the shock absorbing parts 10, and is installed between the vehicle body panel 40 and the interior members 20. Each of the shock absorbing parts 10 has an open surface 10c on the wide diameter side and a closed surface 10b on the narrow diameter side, and also has a line-shaped induction part 12 that is formed on a side face 10a from an edge 10f on the wide diameter side to a point midway toward an edge 10e on the narrow diameter side and that induces a crack when a shock is applied. The shock absorbing parts 10 have a function of absorbing a shock energy caused by a shock load when the shock load is applied to the interior member 20. The base 11 connects the plurality of shock absorbing parts 10 at the edge 10f on the wide diameter side. The sheet-shaped base 11 has a function of supporting the plurality of shock absorbing parts 10 arranged with predetermined spaces therebetween.

The shock absorbing parts 10 of the present embodiment are arranged at even intervals in the longitudinal and lateral directions of the base 11, and integrated with the base 11. The shock absorption structure 1 shown in FIG. 3 has a total of 16 of the shock absorbing parts 10 arranged by 4 rows in the front-rear direction D1 of the motor vehicle and by 4 rows in the vehicle width direction. However, the number of the shock absorbing parts is not limited as far as it is more than one. Each of the shock absorbing parts 10 has an outer shape provided in a circular truncated cone shape, and includes a hollow part HO1. In the shock absorbing part 10, the lower base portion (surface on the wide diameter side) 10c of the circular truncated cone shape is opened and continuous with the hollow part HO1, and the upper base portion (surface on the narrow diameter side) 10b of the circular truncated cone shape is closed. The induction part 12 of the present embodiment is a slit 12a that linearly extends on the side face 10a from the edge 10f of the lower base portion 10c to a point midway toward the edge 10e of the upper base portion 10b. A plurality of such slits 12a are formed on each of the side faces 10a. Each of the slits 12a penetrates the side face 10a in a rectangular shape of a substantially constant width up to a midway height of the side face 10a, and linearly extends so as to orthogonally intersect with the sheet-shaped base 11. The slits 12a, 12a of the present embodiment are formed in positions facing each other with respect to the side face 10a.

In addition, the boundary part between the upper base portion 10b and the side face 10a is provided with a curved part 10d in a manner of drawing a curved surface.

Note that, by forming the shock absorbing parts 10 in a circular truncated cone shape, the mold can be easily opened after molding the shock absorption structure, thus enabling to improve moldability. In addition, by providing the curved part 10d in the boundary part between the upper base portion and the side face, the moldability is further improved when injection molding the shock absorbing parts, and also a better mold releasability is obtained, thus enabling to prevent, as much as possible, occurrence of problems such as defective molding.

The base 11 has a function of connecting the plurality of shock absorbing parts 10, and also serves as a seating surface such as an adhesive applying surface for mounting the shock absorbing parts 10 to the interior members 20 or the vehicle body panel 40. The base 11 is preferably designed with the material and the thickness so as to have a flexibility. This is because, if the base 11 has flexibility, the base 11 can even follow the shape of the interior member having locally curved shape, such as the roof liner interior material 21.

The material composing the shock absorption structure 1 may be any material as long as the material absorbs a shock. However, the material is preferably resin materials (including elastomer) from the viewpoint of appropriate shock absorption. The shock absorption structure 1 formed using the resin material may be made of a foamed material. However, it is preferably a resin molded structure formed of an unfoamed resin material from the viewpoint of more appropriate shock absorption. The resin (including elastomer) composing the resin material is preferably a synthetic resin, and particularly preferably a thermoplastic resin from the viewpoint of providing an appropriate degree of shock absorbing property to the shock absorbing parts. However, thermosetting resin may also be used. From the viewpoint of providing a particularly suitable shock absorbing property to the shock absorbing parts, the thermosetting resin is preferably a resin such as an olefin-based resin including polypropylene and polyethylene, or an olefin-based resin with the addition of elastomer. The resin material may be added with additives such as a filler. The compounding ratio of additive is set to, for example, a weight ratio equal to or less than the weight ratio of the resin from the viewpoint of sufficiently taking advantage of properties of resin. For forming the resin molding material, injection molding, press molding, extrusion molding, and so on may be used.

Because the shock absorbing member described in Japanese Patent Application Publication No. JP-A-2007-137288 and Japanese Patent Application Publication No. JP-A-2007-190971 need be deformed so as to crush the top face or the outer peripheral side face when a shock is applied, a resin material with a Charpy impact strength of 20 J/m² or more (for example, approx. 30 J/m²) is used. Here, the Charpy impact strength refers to the Charpy impact strength specified in JIS K 7111-1 (Plastics—Determination of Charpy impact properties) established on Dec. 20, 2006. The compressive load F-displacement s curve for the shock absorbing member using the resin material as described above has, for example, as shown in FIG. 33B, a region R2 of the displacement s in which the load level is maintained at a substantially constant level after rising in the initial stage of the displacement. Such a load-displacement characteristic may provide an optimal shock absorbing performance. However, it has been found that such an optimal shock absorbing performance as described above is not provided by the shock absorption structure arranged in places such as a place between the roof panel and the roof liner interior material for the purpose of head protection.

As shown in FIG. 33B, according to the load F-displacement s curve of the shock absorbing member of a comparative example, the load F rises in the initial stage of displacement of the shock absorbing member to reach a maximum initial load F1. Then, after the displacement has progressed while maintaining the approximate level of the maximum initial load F1 up to the point where the shock absorbing member is hardly displaced, the load rapidly increases along the curve CU92.

It is considered that, because the shock absorbing member maintains the maximum initial load F1, the maintained load is applied to the occupant head at the second contact and later. That is, a combined load of the reaction force applied by the first contact and the reaction force applied by the second contact is applied to the occupant, thus failing to obtain an optimal shock absorbing performance.

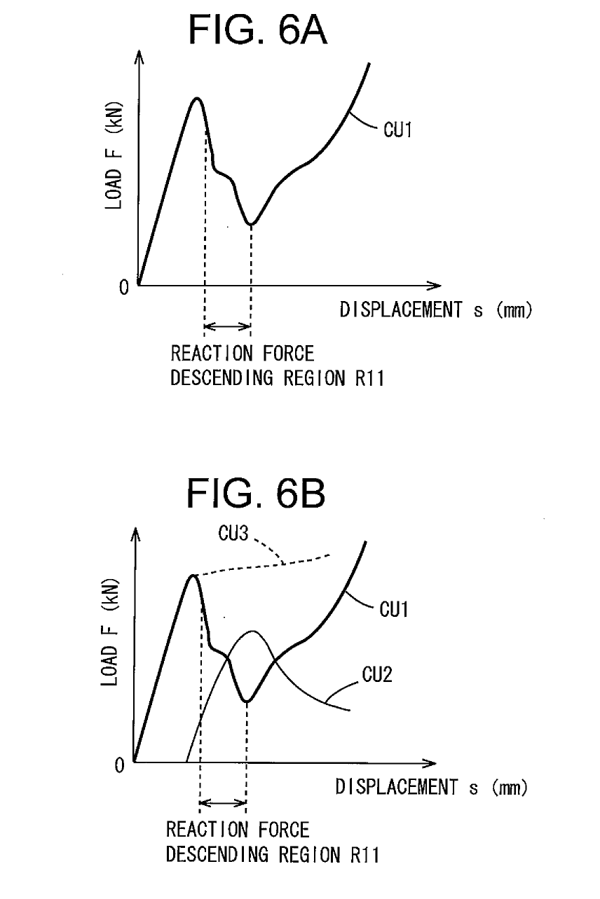

FIG. 6A shows an example of the load F-displacement s curve obtained by conducting an impact test using the shock absorption structure 1 of the present embodiment. In the present embodiment, by structuring the shock absorption structure so as to have the shock absorbing parts characterized by the F-s curve shown in FIG. 6A, the injury index of the occupant head is reduced in the case that the occupant hits the interior member at multiple places when a shock occurs on the motor vehicle, thus improving the shock absorbing performance.

The material of the shock absorption structure 1 for obtaining the load-displacement curve shown in FIG. 6A is preferably a resin material with a Charpy impact strength of 1.0 J/m²or more (more preferably, 1.5 J/m²or more) and 7.1 J/m²or less (more preferably, 6.0 J/m²or less). By making the Charpy impact strength smaller than that of the comparative example, the shock absorbing parts 10 crack easily when a shock is applied, thus obtaining the load-displacement curve shown in FIG. 6A. Here, the Charpy impact strength of the material composing the shock absorbing parts 10 is specified at the above-mentioned lower limit or more in order to obtain an appropriately high level of load after the maximum initial load is generated. On the other hand, the Charpy impact strength is specified at the above-mentioned upper limit or less in order to easily induce cracking of the shock absorbing parts 10 with the induction parts 12 when the shock is applied.

The thickness of the shock absorbing parts 10 made of the resin material is preferably 0.4 to 1.2 mm, and more preferably 0.6 to 1.0 mm. If the thickness of the shock absorbing parts 10 is at the above-mentioned lower limit or more, the load rises appropriately when the shock is received, and the maximum load in the load increasing region R91 increases by an appropriate amount, thus increasing the amount of shock absorption by an appropriate amount. In addition, if the thickness of the shock absorbing parts 10 is at the above-mentioned upper limit or less, the deformation of the side face 10a of the shock absorbing part is appropriately made easy when the shock absorbing part 10 receives the shock, thus obtaining an appropriate level of shock absorbing performance.

The thickness of the base 11 made of the resin material is preferably 0.5 to 1.5 mm, and more preferably 0.7 to 1.3 mm. If the thickness of the base 11 is at the above-mentioned lower limit or more, an appropriate degree of shape retainability is provided to the shock absorption structure, and an appropriate degree of stiffness is obtained, thereby suppressing occurrence of problems such as cracking and deformation. In addition, if the thickness of the base 11 is 1.5 mm or less, deformation of the shock absorbing parts 10 is prevented to an appropriate degree, thus suppressing degradation of shock absorbing performance.

Note that the base 11 and the shock absorbing parts 10 may be provided either in the same thickness or in different thicknesses. In addition, the base 11 and the shock absorbing parts 10 may be provided of the same material or of different materials.

When denoting the height of the shock absorbing parts 10 as H as shown in FIG. 4B, the height h of each of the slits 12a is preferably ( 4/7) H or more and ( 6/7) H or less. Here, as shown in FIG. 4B, the height H of the shock absorbing parts means the length from the surface of the base 11 on which the shock absorbing parts 10 are connected to the upper base portion 10b. The height h of the slit means the height from the edge 10f of the lower base portion 10c that is connected to the base 11. The width of the slits 12a is preferably 2 mm or more and 4 mm or less. If the width of the slits 12a is 2 mm or more, fracture of the shock absorbing parts 10 is appropriately made easy, thus obtaining an appropriate level of shock absorbing performance. In addition, if the width of the slits 12a is 4 mm or less, the peak load of the load-displacement curve in the initial stage of displacement takes an appropriately high value, thus obtaining an appropriate level of shock absorbing performance.

Moreover, from the viewpoint of obtaining a favorable shock absorbing performance, the line-shaped induction part 12 is preferably formed from the edge 10f of the lower base portion. It is presumed that, if the induction part is formed from the edge 10e of the upper base portion, the upper base portion side is easily broken by a low-level load whereas the lower base portion side that is not formed with the induction part is difficult to crush because of a high second moment of area and a low vertical-to-horizontal aspect ratio, and thus a transition to a bottoming state in which the load rapidly increases on the load-displacement curve occurs earlier. On the other hand, the shock absorption structure 1 is formed with the induction part 12 on the side of the lower base portion 10c having a relatively large diameter. Therefore, it is presumed that the load is received by whole of the shock absorbing parts in the initial stage of displacement, and after the maximum initial load is generated, approximately whole of the shock absorbing parts breaks, thus moving the transition to the bottoming state toward the high-displacement side. For this reason, the shock absorption structure 1 has the line-shaped induction part 12 that is formed on the side face 10a from the edge 10f on the wide diameter side to a point midway toward the edge 10e on the narrow diameter side.

Note that, when providing the shock absorbing part with a plurality of such line-shaped induction parts, it is preferable to provide the induction parts at even intervals. This makes it possible to break the shock absorbing parts in a balanced manner so as to stabilize the shock absorbing performance.

The height H of the shock absorbing parts 10 may or may not be large enough to contact the vehicle body panel or the interior member.

Next, operation and effect of the shock absorption structure 1 will be described.

As exemplified in FIG. 6A, a load F-displacement s curve CU1 for the shock absorption structure 1 of the present embodiment is a curve showing that the maximum initial load is generated in the initial stage of displacement, and then a reaction force descending region R11 in which the load temporarily drops appears. This is considered to be caused by the following reason.

When a shock is applied to the shock absorption structure 1, the shock absorbing parts 10 are first displaced until the maximum initial load is generated. It is considered that a crack is generated from the slit 12a on the side face 10a in a certain stage of this displacement. As this crack develops, the reaction force descending region R11 of the F-s curve is created, and the shock absorbing parts 10 are broken, thus reducing the reaction force applied to the occupant.

If the occupant contacts the interior members in two stages, a compressive load of an F-s curve CU2 generated by the second contact is added to the reaction force in the reaction force descending region R11, as shown in FIG. 6B. Here, the horizontal axis of FIG. 6B represents the displacement s of the occupant, where the displacement s=0 at the time when the occupant head first hits the interior member. The vertical axis of FIG. 6B represents the input load F applied to the occupant head. If the component such as the deployment guide member is arranged on the back side of the interior member in a position corresponding to the jaw of the occupant, the reaction force by the compressive load of the component is applied to the occupant head. In the region appearing after the compressive load is generated in the initial stage of displacement, the load of an F-s curve CU3 that is created by combining the F-s curves obtained by the first and the second contacts is smaller than that of the comparative example shown in FIG. 33B because of existence of the reaction force descending region R11. As a result, the injury index of the occupant head can be reduced when a motor vehicle crash test is conducted, and the function for occupant head protection can be improved when a shock occurs on the motor vehicle.

As a result of the above, according to the present invention, it is possible to provide a shock absorption structure for vehicle that can improve the shock absorbing performance in the case that the occupant hits the interior member at multiple places when a shock occurs on the motor vehicle.

### EXAMPLES

The present invention will be specifically described below by showing examples of the first embodiment. However, the present invention is not limited by the examples.

[Test Method]

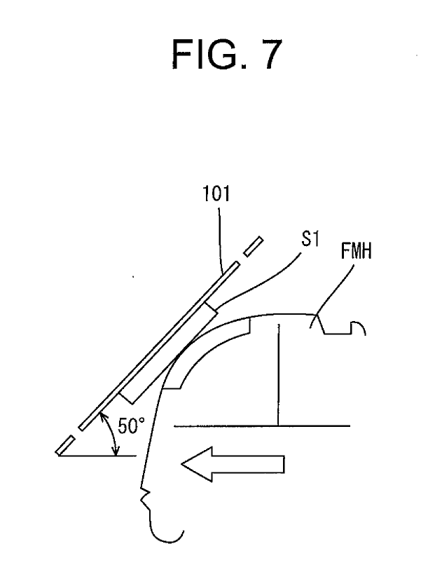

According to the test method specified in Federal Motor Vehicle Safety Standard (FMVSS) 201 (U), the displacement s and the response load F of each of shock absorption structure samples were measured to obtain the load-displacement curve. Specifically, as shown in a schematic diagram in FIG. 7, a head of dummy with a mass of 4.54 kg that is called a free motion headform (FMH) was impacted at a speed of 24 km/h against a shock absorption structure sample 51 installed on a rigid body PL1 inclined at an elevation angle of 50°, and then the load-displacement curve was obtained.

The shock absorption structure sample 51 used in the test had a shape in which the shock absorbing parts 10 are arranged at even intervals in rows of 4×4 on the sheet-shaped base 11, and was integrally formed by injection molding of polypropylene, as shown in FIG. 3. Here, the base 11 had a substantially square shape of 100×100 mm; the thickness of the base 11 and the shock absorbing parts 10 was 0.75 mm; the diameter of the upper base portions 10b of the shock absorbing parts 10 was 10 mm; the height H of the shock absorbing parts 10 was 14 mm; and the center-to-center distance between the shock absorbing parts 10 was 25 mm.

As the shock absorption structure samples S1, samples of Examples 1 to 13 and samples of Comparative Examples 1 to 3 were prepared with varying the slit height h, slit width, number of slits, slit shape, and Charpy impact strength. Table 1 shows the slit height, the slit width, the number of slits, and the Charpy impact strength of each of the examples and the comparative examples. Note that no slit was formed in Comparative Example 1; the slit was formed from the edge 10e of the upper base portion 10b to a midway height on the side face 10a in Comparative Example 2; and the slit 12a was formed to the same height as the height H of the shock absorbing parts 10 in Comparative Example 3.

TABLE 1

| | | | | Charpy |
|---|---|---|---|---|
| | | | Number of | impact |
| | Slit height h | Slit width | slits | strength |
| Example 1 | 7 mm | 2 mm | 2 | 4.5 J/m² |
| Example 2 | 8 mm | 2 mm | 2 | 4.5 J/m² |
| Example 3 | 9 mm | 2 mm | 2 | 4.5 J/m² |
| Example 4 | 10 mm | 2 mm | 2 | 4.5 J/m² |
| Example 5 | 12 mm | 2 mm | 2 | 4.5 J/m² |
| Example 6 | 10 mm | 4 mm | 2 | 4.5 J/m² |
| Example 7 | 10 mm | 2 mm | 1 | 4.5 J/m² |
| Example 8 | 10 mm | 2 mm | 3 | 4.5 J/m² |
| Example 9 | 10 mm | 2 mm | 4 | 4.5 J/m² |
| Example 10 | 10 mm | 2 mm | 2 | 7.1 J/m² |
| Example 11 | 10 mm | 2 mm | 2 | 24.0 J/m² |
| Example 12 | 12 mm | 2 mm (Oblique 1) | 2 | 4.5 J/m² |
| Example 13 | 12 mm | 2 mm (Oblique 2) | 2 | 4.5 J/m² |
| Comparative | No slit | — | — | 4.5 J/m² |
| Example 1 | | | | |
| Comparative | 9 mm | 2 mm | 2 | 4.5 J/m² |
| Example 2 | | | | |
| Comparative | 14 mm | 2 mm | 2 | 4.5 J/m² |
| Example 3 | | | | |

[Slit Height h]

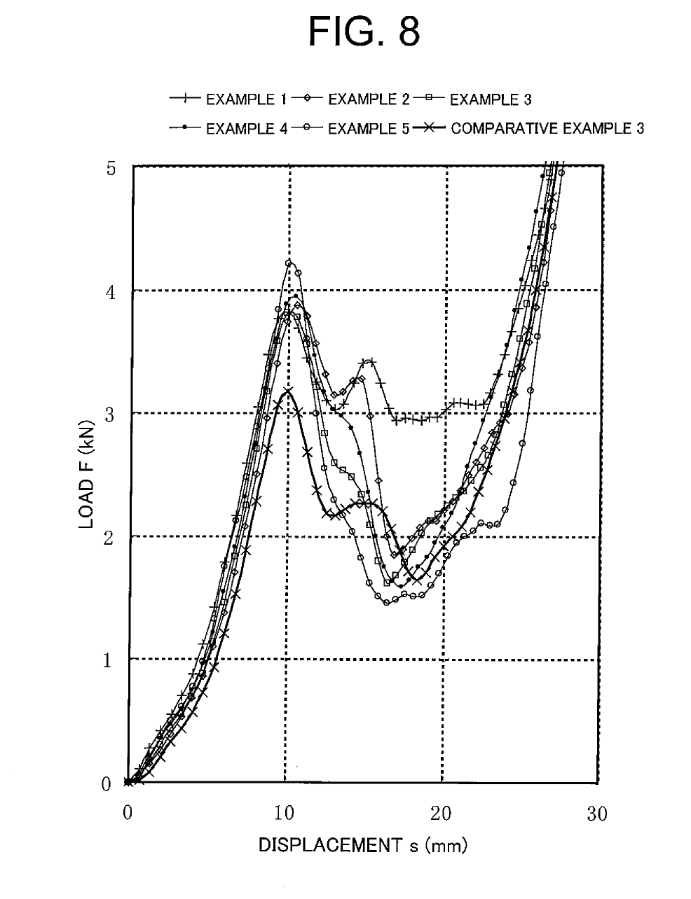

FIG. 8 is a diagram showing the load-displacement curves obtained from the impact tests of Examples 1 to 5 and of Comparative Example 3 with varying the height h of the slit formed on the side face of the shock absorbing part.

In Example 1 in which the slit height h is the lowest (h/H is ½), the reduction in load in the reaction force descending region stagnates around 3 kN. In addition, as the slit height h gradually increases, the maximum initial load gradually increases. Also, as the slit height h gradually increases, the amount of reduction in the load increases in the reaction force descending region. In Comparative Example 3 in which the slit height is 14 mm, the maximum initial load is much smaller compared with Examples 1 to 5, and after the load has decreased from the maximum initial load, a region appears in which the load increases again.

That is, when the slit height h increases to 4/7 or more of the height H of the shock absorbing parts, the value of the maximum initial load on the load-displacement curve increases to an appropriate value so as to increase the amount of shock energy absorption, and the amount of reduction in load in the reaction force descending region increases to an appropriate value so as to reduce the reaction force applied to the occupant. On the other hand, when the slit height h decreases to 6/7 or less of the height H of the shock absorbing parts, the maximum initial load on the load-displacement curve increases to an appropriate value so as to increase the amount of shock energy absorption, and the reaction force applied to the occupant decreases.

As a result of the above, it has been found that the slit height h should preferably be ( 4/7) H or more and ( 6/7) H or less.

[Slit Width]

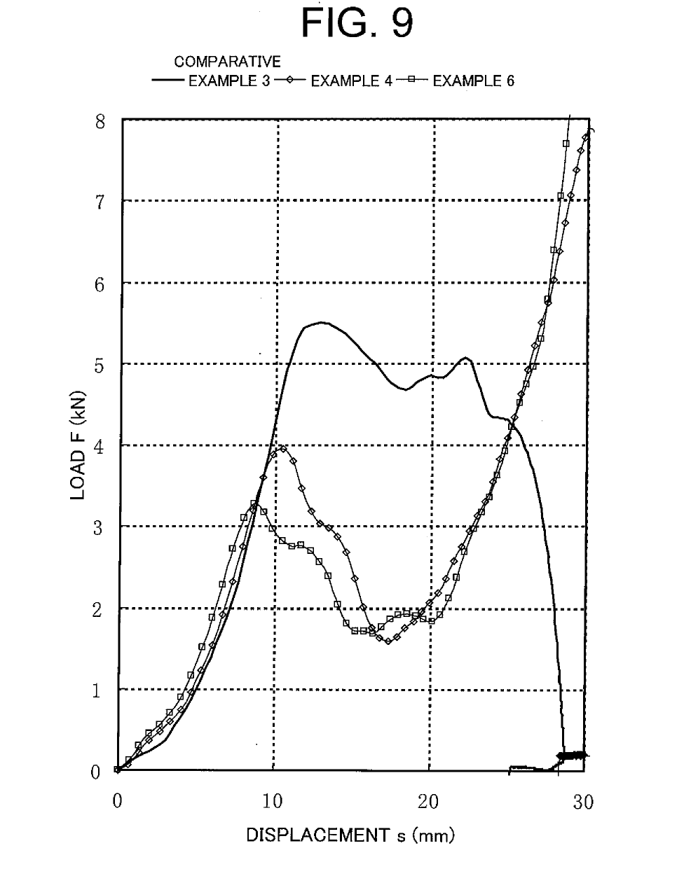

FIG. 9 is a diagram showing the load-displacement curves obtained from the impact tests of Examples 4 and 6 with varying the slit width, and of Comparative Example 1 with no slit formed.

In Comparative Example 1, the reaction force descending region due to fracture of the shock absorbing parts 10 does not appear. On the other hand, in Example 4 in which the slit width is 2 mm, a favorable waveform curve is obtained because the maximum initial load appears in the initial stage of displacement and then the reaction force descending region also appears in which the load decreases. In addition, in Example 6 in which the slit width is 4 mm, a waveform curve is obtained in which the reaction force descending region appears although the maximum initial load in the initial stage of displacement is less than that of Example 4.

That is, if the slit width is 2 mm or more, the fracture of the shock absorbing parts 10 easily occurs after the maximum initial load is generated, thus enabling to reduce the reaction force applied to the occupant. In addition, if the slit width is 2 mm or more and 4 mm or less, the value of the maximum initial load on the load-displacement curve is appropriately high and a large amount of shock energy is absorbed, thus enabling also to reduce the reaction force given to the occupant.

As a result of the above, it has been found that the slit width should preferably be 2 to 4 mm in order to obtain the reaction force descending region, and the slit width should preferably be in the vicinity of 2 mm in order to absorb more shock energy.

[Number of Slits]

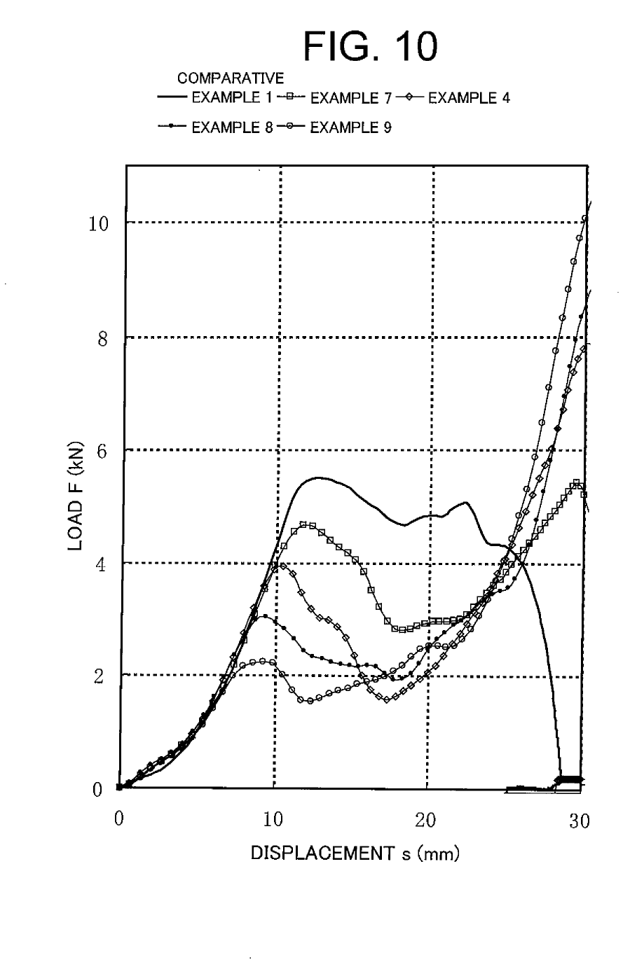

FIG. 10 is a diagram showing the load-displacement curves obtained from the impact tests of Examples 4, 7, 8, and 9 with varying number of slits, and of Comparative Example 1 with no slit formed.

On each of the load-displacement curves of Examples 4, 7, 8, and 9 in which the numbers of slits formed are 1, 2, 3, and 4, the reaction force descending region appears after the maximum initial load is generated. On the other hand, in Comparative Example 1 with no slit formed, the reaction force descending region does not appear after the generation of the maximum initial load.

As a result of the above, it has been found that the number of slits should preferably be 2 to 4.

[Slit Position]

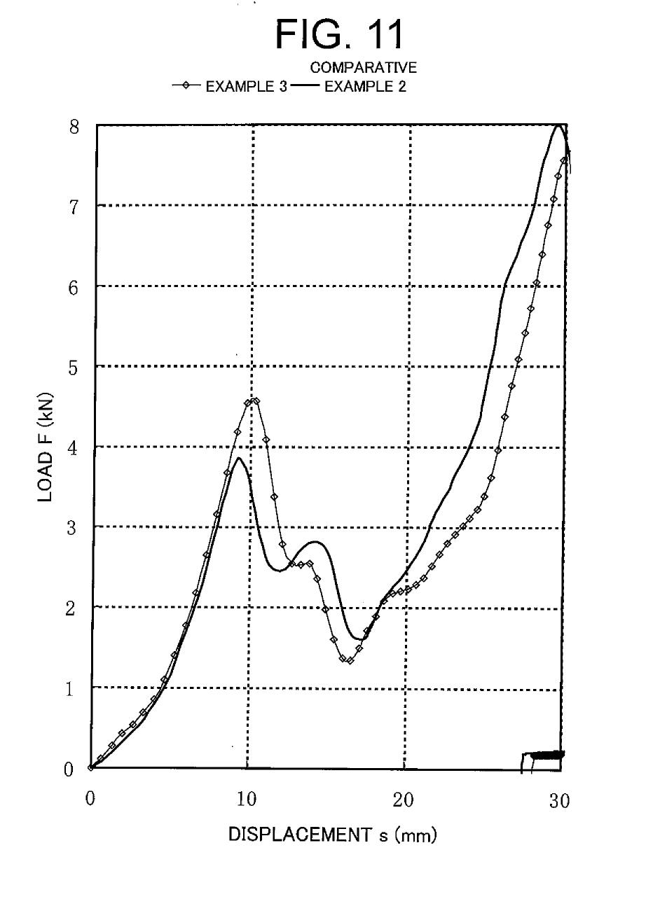

FIG. 11 is a diagram showing the load-displacement curves obtained from the impact tests of Comparative Example 2 and Example 3. Here, in the sample of Example 3, a slit with a height of 9 mm is formed from the edge 10f of the lower base portion to a point midway toward the edge 10e of the upper base portion of the shock absorbing part.

On the other hand, in the sample of Comparative Example 2, a slit with a height of 9 mm is formed from the edge 10e of the upper base portion to a point midway toward the edge 10f of the lower base portion of the shock absorbing part.

In Comparative Example 2, the value of the maximum initial load in the initial stage of displacement is smaller than that of Example 3; the load increases again after decreasing from the maximum initial load so as to form a small peak; and transition to the bottoming state occurs earlier compared with Example 3. On the other hand, in Example 3, the reaction force descending region appears after the generation of the maximum initial load, and the load-displacement curve has a larger peak and valley compared with Comparative Example 2.

As a result of the above, it has been found that the slit is preferably formed not from the edge 10e of the upper base portion but from the edge 10f of the lower base portion. This is presumed to be caused by the following reason.

The outer shape of the shock absorbing part 10 is a frustum shape. Therefore, in the case of Comparative Example 2, the portion formed with the slit on the side of the upper base portion 10b has a smaller second moment of area than that of the portion on the side of the lower base portion 10c, and thus the portion on the side of the upper base portion is easily broken by a low-level load. The portion on the lower base portion side formed with no slit is difficult to crush because of a high second moment of area and a low vertical-to-horizontal aspect ratio, and thus the transition to the bottoming state occurs earlier. On the other hand, in the case of Example 3, because the slit is formed on the side of the lower base portion 10c having a relatively large diameter, the load is received by whole of the shock absorbing part in the initial stage of displacement, and after the maximum initial load is generated, approximately whole of the shock absorbing part breaks, thus moving the transition to the bottoming state toward the high-displacement side. For this reason, it is presumed that a more favorable shock absorbing performance is obtained by forming the slit from the edge of the lower base portion than by forming the slit from the edge of the upper base portion.

[Charpy Impact Strength]

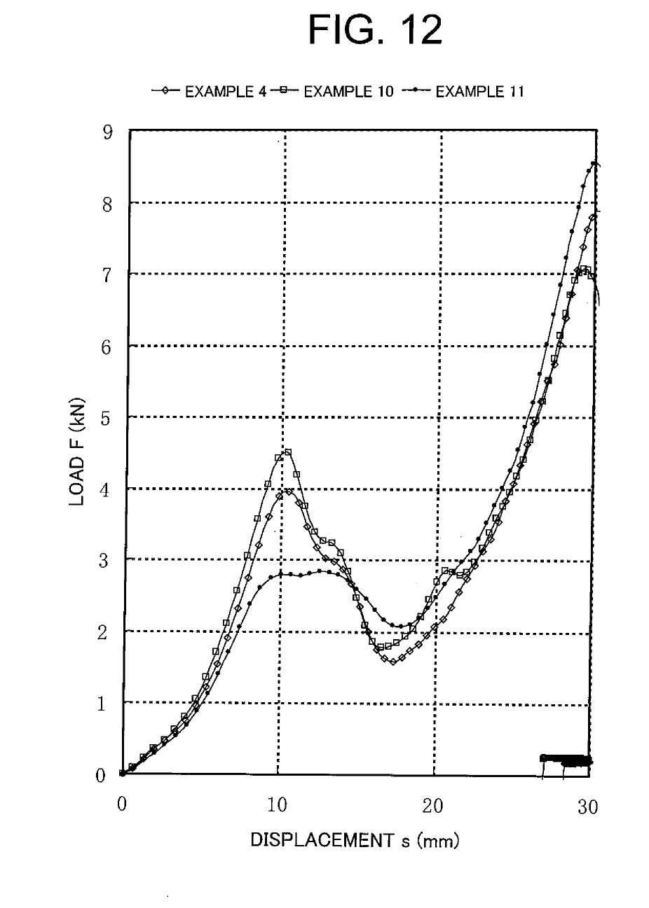

FIG. 12 is a diagram showing the load-displacement curves obtained from the impact tests of Examples 4, 10, and 11 with different levels of the Charpy impact strength specified in JIS K 7111-1.

Favorable maximum initial loads and reaction force descending regions appear in Example 4 with a Charpy impact strength of 4.5 J/m² and Example 10 with a Charpy impact strength of 7.1 J/m². On the other hand, in Example 11 with a Charpy impact strength of 24 J/m², the curve shows a smaller maximum initial load and a smaller reduction in load in the reaction force descending region, compared with the other examples.

As a result of the above, it has been found that the Charpy impact strength should preferably be 7.1 J/m²or less, and more preferably be 4.5 J/m²or less.

[Slit Directions]

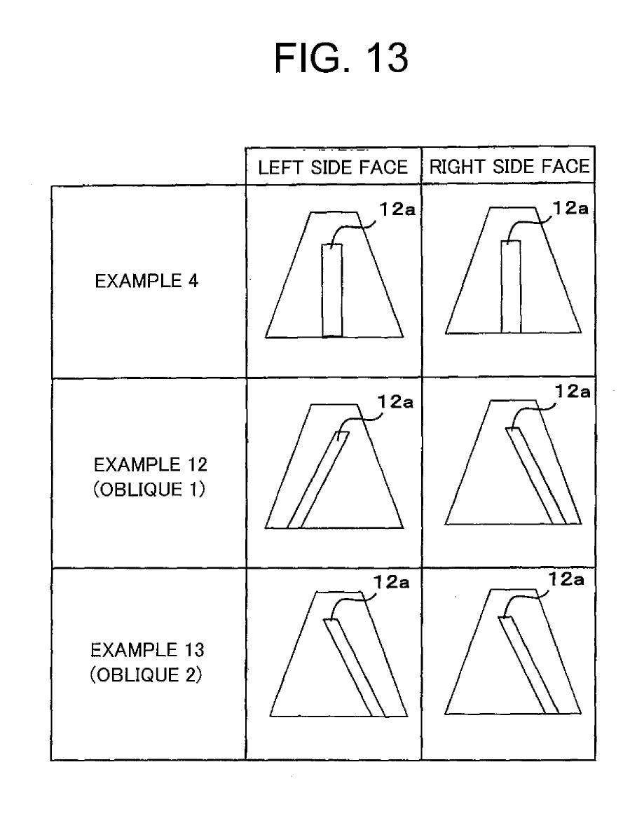

FIG. 13 shows diagrams for explaining slit directions of Examples 4, 12, and 13. In Example 4, the slits 12a are formed substantially perpendicular to the base 11. In Example 12, the slits 12a are formed oblique to the base 11, and the two mutually facing slits are formed in the same oblique direction (described as Oblique 1 in the drawing). In Example 13, the slits 12a are formed oblique to the base 11, and the two mutually facing slits are formed in the oblique directions not coincident with each other (described as Oblique 2 in the drawing).

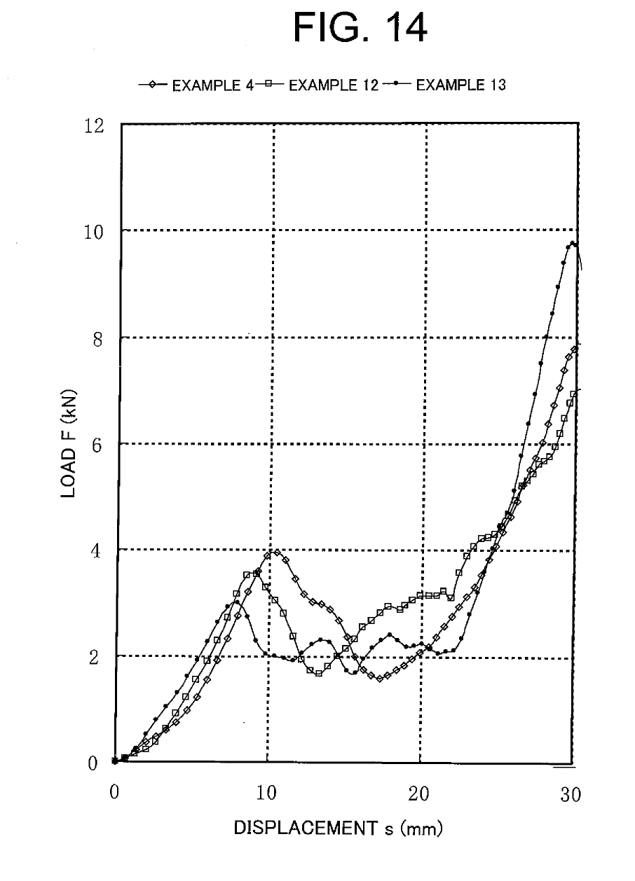

FIG. 14 is a diagram showing the load-displacement curves obtained from the impact tests of Examples 4, 12, and 13. In Example 4, the value of the maximum initial load is higher than those of Examples 12 and 13, and the load thereafter decreases in a downward-sloping manner. On the other hand, in Example 12, the maximum initial load is lower than that of Example 4, with the load thereafter decreasing once but immediately increasing. In Example 13, the value of the maximum initial load is the lowest, with the load thereafter repeating increasing and decreasing until resulting in the bottoming.

As a result of the above, it has been found that the slit directions should preferably be substantially perpendicular to the base 11.

### (2) Second Embodiment

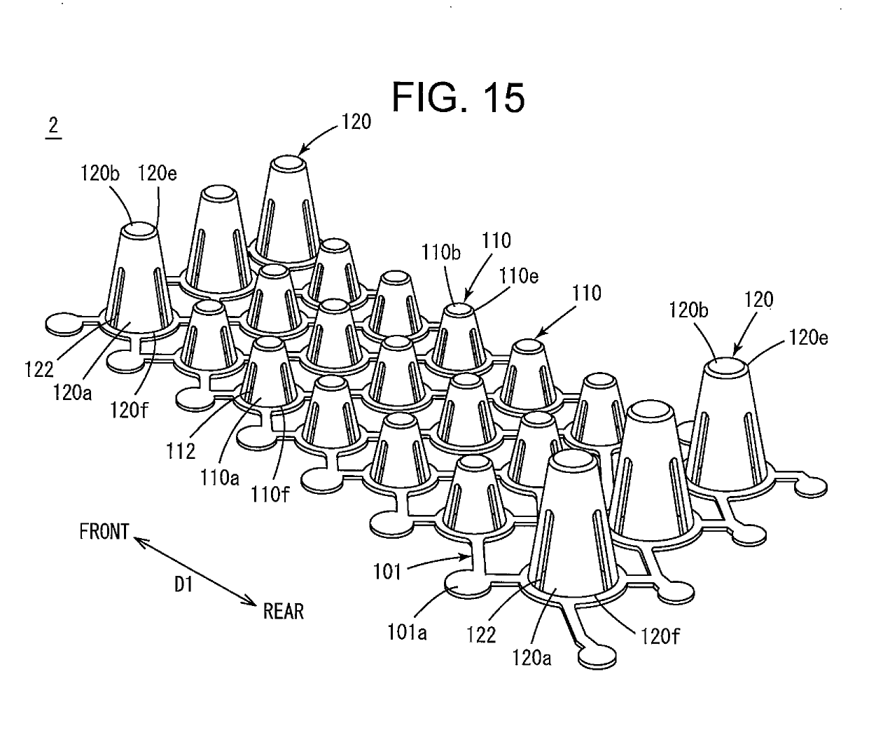

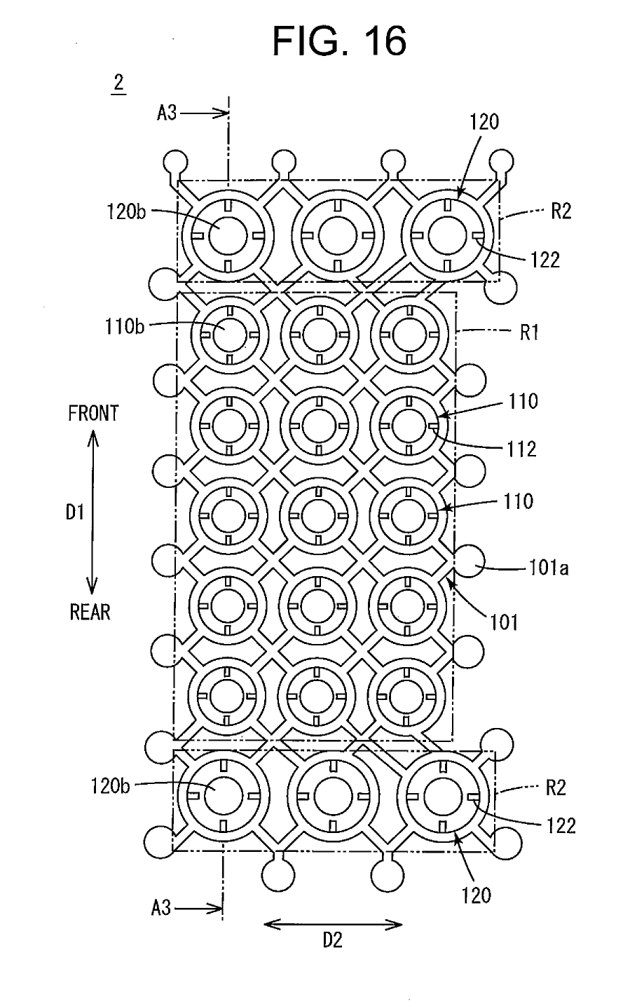

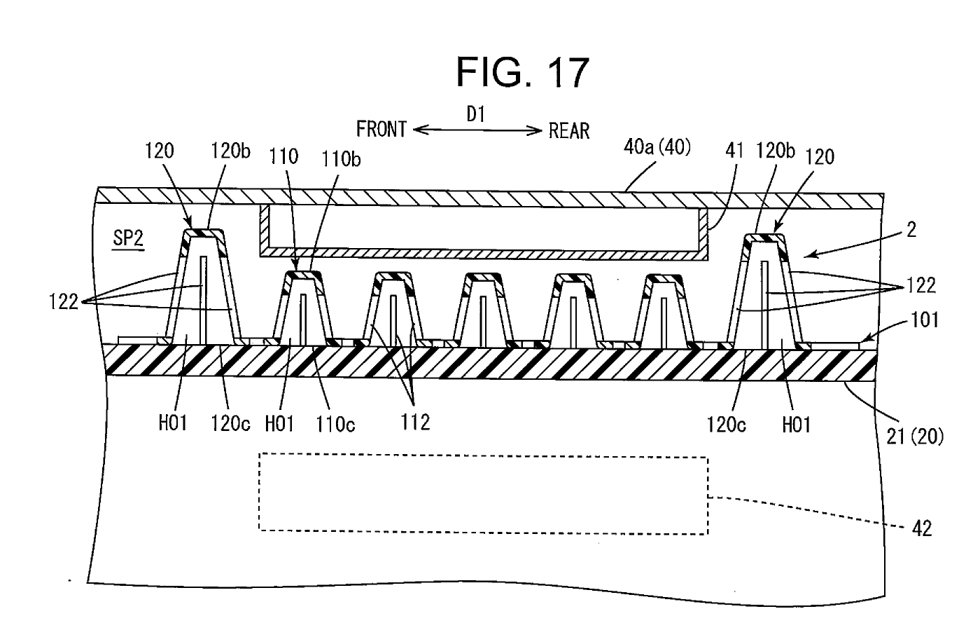

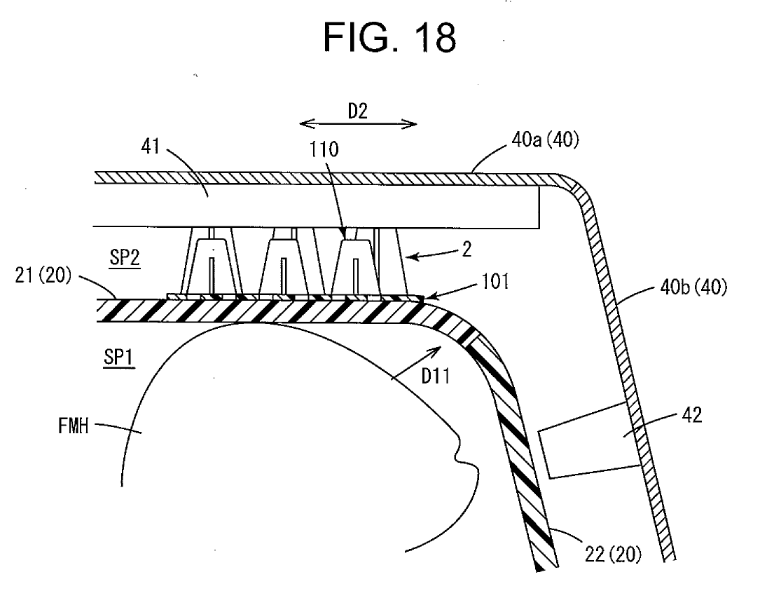

FIG. 15 is an exemplary illustration of a perspective view showing an external appearance of a shock absorption structure 2 for vehicle according to a second embodiment; FIG. 16 is an exemplary illustration of a plan view of the shock absorption structure 2; FIG. 17 is a part cross-sectional view illustrating an example of a part of the motor vehicle in a vertical section parallel to the front-rear direction; and FIG. 18 is a part cross-sectional view illustrating the example of the part of the motor vehicle in a vertical section parallel to the vehicle width direction.

A plurality of shock absorbing parts of the shock absorption structure 2 include a plurality of first shock absorbing parts 110 and a plurality of second shock absorbing parts 120 having a height different from that of the first shock absorbing parts 110. In addition, the plurality of shock absorbing parts 110, 120 of the shock absorption structure 2 are structured by combining a first area R1 composed of the plurality of first shock absorbing parts 110 and a second area R2 composed of the plurality of second shock absorbing parts 120. Each of the shock absorbing parts 110, 120 that is cup-shaped has an open surface (lower base portion 110c, 120c) on the wide diameter side and a closed surface (upper base portion 110b, 120b) on the narrow diameter side, and also has a line-shaped induction part 112, 122 that is formed on a side face 110a, 120a from an edge 110f, 120f on the wide diameter side to a point midway toward an edge 110e, 120e on the narrow diameter side and that induces a crack when a shock is applied. A connecting part 101 connects these shock absorbing parts 110, 120 at the edges 110f, 120f on the wide diameter side.

The shock absorption structure 2 has a total of 21 of the shock absorbing parts 110, 120 arranged by 3 rows in a vehicle width direction D2 and by 7 rows in the front-rear direction D1 of the motor vehicle. Here, three of the parts in the front row and three of the parts in the rearmost row serve as the shock absorbing parts 120 in the second area R2, and 15 of the parts interposed between sections of the second area R2 serve as the shock absorbing parts 110 in the first area R1. A height H1 of the first shock absorbing parts 110 is smaller than a height H2 of the second shock absorbing parts 120. The difference in height H2-H1 between the shock absorbing parts 110 and 120 can be, for example, 5 mm or more.

The induction parts 112, 122 are the same slits as those of the first embodiment, and four slits are formed on each of the side faces 110a, 120a of the shock absorbing parts. The number of the slits formed on each of the shock absorbing parts may obviously be other than four. The height of each of the slits 112 is preferably ( 4/7) H1 or more and ( 6/7) H1 or less, and the height of each of the slits 122 is preferably ( 4/7) H2 or more and ( 6/7) H2 or less.

The connecting part 101 of the present embodiment protrudes from the edges 110f, 120f of the lower base portions of the shock absorbing parts in directions displaced by substantially 45° from the front-rear direction D1 and the vehicle width direction D2, and bridges the shock absorbing parts 110, 120 lined in those directions. In addition, the bridging parts protruding in those directions intersect each other, and at the intersecting locations adjoined by the shock absorbing parts 110, 120 in the front-rear and right-left directions, the connecting part 101 is provided in a cross shape. By connecting the shock absorbing parts 110, 120 by using the bridging parts, bending performance of the shock absorption structure is improved, and in the case of pasting the shock absorption structure on the curved part such as the roof liner interior material or the roof panel, the shock absorption structure can easily fit the curved part. In addition, in order to increase the surface area for bonding to the interior member and the vehicle body panel, swelled parts 101a of a substantially circular shape are provided at ends of the bridging parts protruding outward from the shock absorbing parts 110, 120 in the outermost row. Then, the shock absorption structure 2 is mounted to the interior member 20, for example, by bonding the connecting part 101 having the swelled parts 101a to the back surface of the interior member 20 with adhesive. The shock absorption structure 2 may be mounted to the vehicle body panel 40, for example, by bonding the connecting part 101 to the surface on the passenger compartment side of the vehicle body panel 40.

The material shown in the first embodiment may be used for forming the shock absorption structure 2. The dimensions such as the thickness of the shock absorption structure 2 are the same as those in the first embodiment.

The shock absorption structure 2, including the shock absorption structure 1 of the first embodiment, is arranged, for example, near an edge in the vehicle width direction D2 on the back surface of the roof liner interior material 21. In this case, the shock absorption structure 2 is arranged, for example, in a position at a certain distance toward inside of the passenger compartment from the upper corner of the motor vehicle. If the shock absorption structure 2 is arranged near the center of the roof liner interior material where the roof panel is relatively highly flexible, the injury index of the occupant head is not likely to be large. In addition, on a side face of the passenger compartment, the curtain airbag is deployed to protect the occupant when a shock occurs on the motor vehicle. However, at the upper corner of the motor vehicle, the vehicle body panel may be attached with comparatively hard components such as a deployment guide member for curtain airbag, assist grips, coat hooks, and connecting members for pillar panels and interior members, and the jaw of the occupant may hit the interior members at the places where these components are arranged. FIG. 18 illustrates an example in which a component 42 is attached to a pillar 40b on the back side of the pillar garnish interior material 22 at a place hit by the jaw of the occupant dummy FMH in the impact test. The component 42 shown is provided at a place closer to the outside in the vehicle width direction than the shock absorbing parts 110 in the first area R1, as shown in FIG. 17.

As a result of the above, the injury index of the occupant head tends to be relatively large because the input load applied to the occupant forehead is combined with the input load applied to the occupant jaw.

Therefore, as exemplified in FIG. 18, the shock absorption structure 2 that is arranged on the back surface of the roof liner interior material 21 near the pillar garnish interior material 22 is placed in the position at a certain distance toward inside of the passenger compartment from the edge in the vehicle width direction D2. Obviously, the shock absorption structure may be arranged on the back surface of the roof liner interior material 21 at a place distant from the pillar garnish interior material 22, or may be arranged on the edge in the front-rear direction D1 of the roof liner interior material 21 with the longer direction oriented in the vehicle width direction D2. Moreover, the shock absorption structure of an L-shape may be arranged at four corners of the roof liner interior material 21.

In addition, the shock absorption structure 2 is longer in the front-rear direction D1 than in the vehicle width direction D2. The shock absorption structure 2 may be formed wholly integrally in the front-rear direction D1 of the motor vehicle, or may be formed in several sections divided in the front-rear direction D1 for convenience of molding. The number of the shock absorbing parts 110, 120 arranged in the vehicle width direction D2 may be other than three, and may be, for example, two or four.

As shown in FIGS. 17 and 18, in the shock absorption structure 2 of the present embodiment, the shock absorbing parts 110, 120 have different heights in accordance with a reinforcement 41 arranged between the space SP2 formed between the vehicle body panel 40 and the interior member 20. The reinforcement 41 is a long metal member mounted to the vehicle body panel 40 in order to reinforce the vehicle body, and, in the example shown in FIGS. 17 and 18, attached to the roof panel 40a with the longer direction oriented in the vehicle width direction D2. The second shock absorbing parts 120 in the second area R2 serving as the front and the rear edges of the shock absorption structure 2 have a height higher than the space between the connecting part 101 and the reinforcement 41. Consequently, the first shock absorbing parts 110 in the first area R1 facing the reinforcement 41 is lower in height than the second shock absorbing parts 120.

Note that the height H1 of the first shock absorbing parts 110 may or may not be large enough to contact the reinforcement 41. Also, the height H2 of the second shock absorbing parts 120 may or may not be large enough to contact the vehicle body panel.

Moreover, in the shock absorption structure installed in a place facing a component other than the reinforcement, it is possible to arrange the shock absorbing parts of a relatively small height in the first area facing a component convexed toward the interior member, and arrange the shock absorbing parts of a relatively large height in the remaining area.

Note that, for the reason described in the first embodiment, the Charpy impact strength of the material composing the shock absorption structure 2 is preferably 1.0 J/m² or more and 7.1 J/m²or less, and more preferably 1.5 J/m²or more and 6.0 J/m²or less.

As described above, by combining the shock absorbing parts of different heights, any space can be filled while keeping clear of reinforcements and components. Accordingly, the degree of freedom increases in installation location of the shock absorption structure.

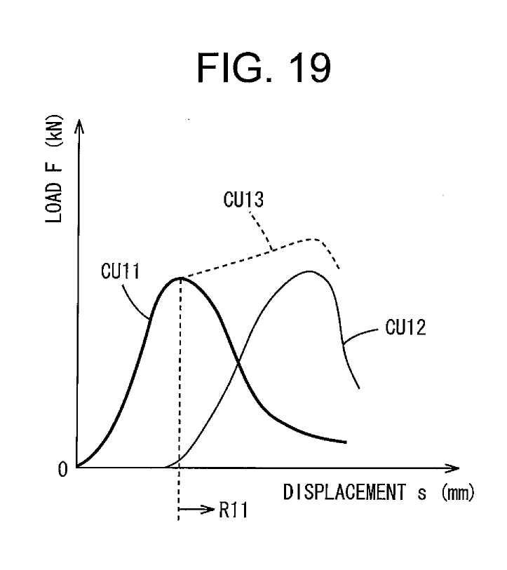

FIG. 19 illustrates an example of change in the load F applied to the head of the occupant dummy FMH when conducting the impact test using the motor vehicle shown in FIG. 18. Here, the horizontal axis represents the displacement s of the occupant dummy FMH, where the displacement s=0 at the time when the forehead of the occupant dummy FMH hits the interior member 20. The vertical axis represents the input load F applied to the head of the occupant dummy FMH.

When the forehead of the occupant dummy FMH has moved in the direction of an arrow D11 in FIG. 18 and hits the roof liner interior material 21, a compressive load acts on the shock absorbing parts 110, 120, and the reaction force F increases until reaching the maximum initial load. Then, cracks are generated from the induction parts 112, 122 on the side faces 110a, 120a, and the shock absorbing parts 110, 120 are broken, thus generating the reaction force descending region R11 in which the reaction force decreases. In FIG. 19, a load-displacement curve CU11 represents an input load F₁₁ applied to the forehead of the occupant dummy FMH.

In addition, when the jaw of the occupant dummy FMH hits the interior member 20 such as the pillar garnish interior material 22 after the contact of the forehead, a compressive load acts on the component 42, and the reaction force F increases. In FIG. 19, a load-displacement curve CU12 represents an input load F₁₂ applied to the jaw of the occupant dummy FMH.

The input load F applied to the head of the occupant dummy FMH is approximately a total of the load F₁₁ represented by the load-displacement curve CU11 and the load F₁₂ represented by the load-displacement curve CU12. In FIG. 19, a load-displacement curve CU13 in a dashed line represents the change in the total load F. As shown in FIG. 19, because the load-displacement curve CU11 generated by the shock absorbing parts 110, 120 has the reaction force descending region R11, the curve CU13 of the combined load F is suppressed from increasing after the input load F₁₁ applied to the head has reached the maximum initial load. Accordingly, the injury index of the occupant head can also be reduced by the shock absorption structure 2, and thus the shock absorbing performance can be improved in the case that the occupant contacts the interior member in multiple stages when a shock occurs on the motor vehicle.

In addition, the shock absorption structure 2 may also be used in the case in which the forehead and the jaw of the occupant hit the interior member almost at the same time.

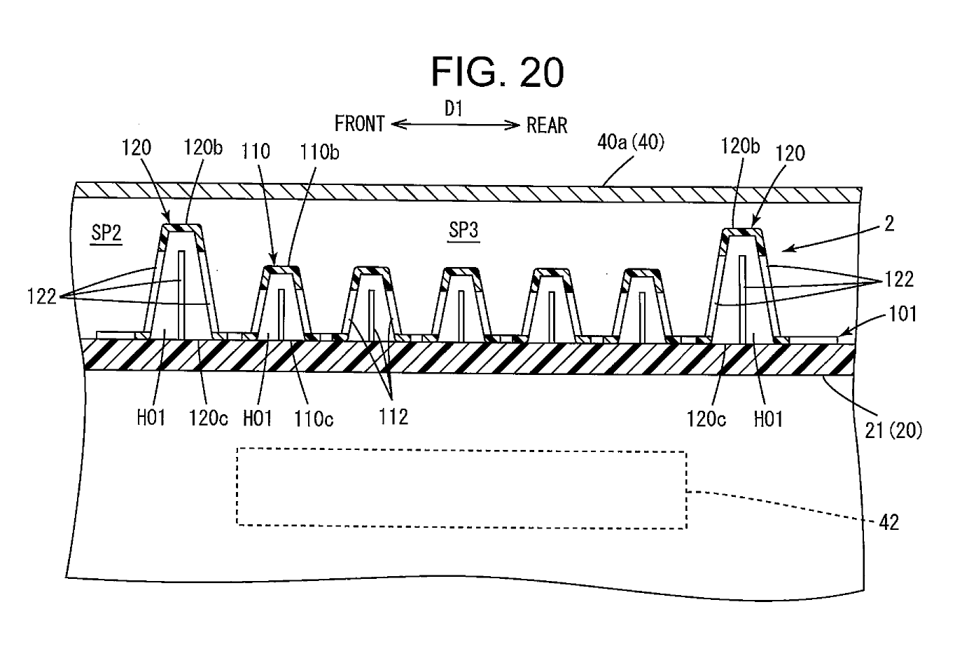

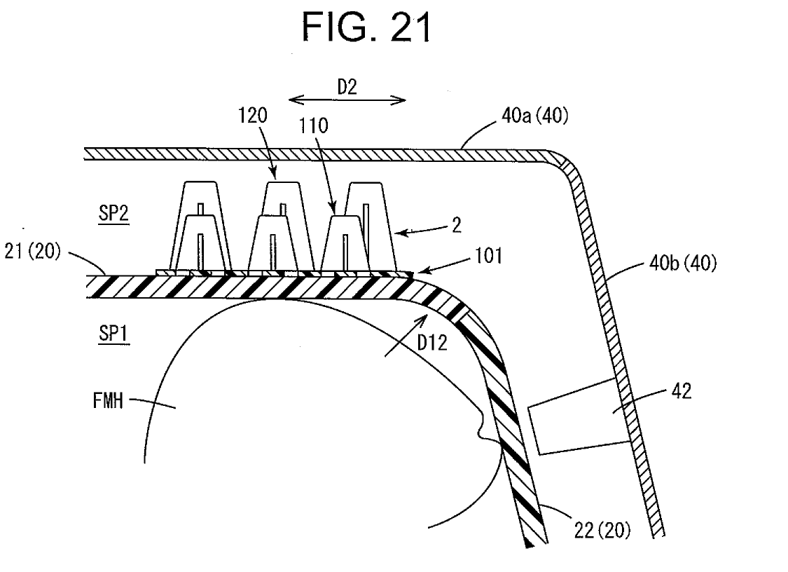

FIG. 20 is a part cross-sectional view illustrating an example of a part of the motor vehicle in a vertical section parallel to the front-rear direction, and FIG. 21 is a part cross-sectional view illustrating the example of the part of the motor vehicle in a vertical section parallel to the vehicle width direction.

The shock absorption structure 2 shown in FIG. 20 is arranged in the space SP2 between the vehicle body panel 40 and the interior member 20 at a place where no components such as the reinforcement exist. By this arrangement, a space SP3 is formed between the first shock absorbing parts 110 of a relatively small height and the vehicle body panel 40. FIG. 21 illustrates an example in which the component 42 is attached to the pillar 40b on the back side of the pillar garnish interior material 22 at a place where the jaw of the occupant dummy FMH hits in the impact test. The component 42 shown is provided at a place closer to the outside in the vehicle width direction than the shock absorbing parts 110 in the first area R1, as shown in FIG. 20.

In the case in which the forehead of the occupant dummy FMH hits the interior member 20 at the same time as the jaw of the occupant dummy FMH hits the interior member 20 in the impact test, the load input from the forehead can be delayed from the load input from the jaw by arranging the shock absorption structure so as to form the space SP3 between the shock absorbing parts of a relatively small height and the roof panel.

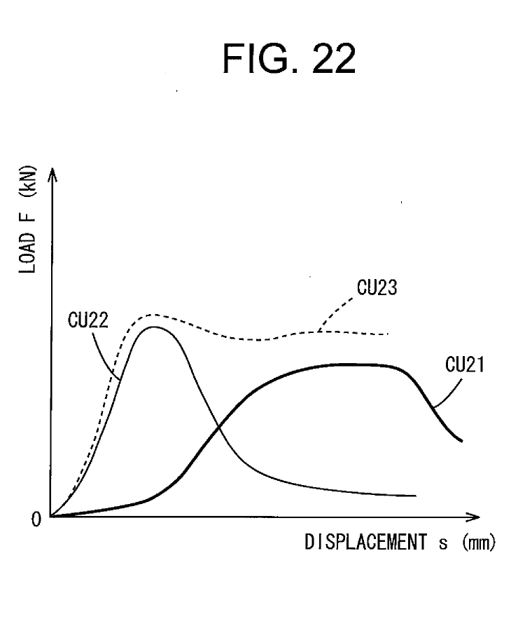

FIG. 22 illustrates an example of change in the load F applied to the head of the occupant dummy FMH when conducting the impact test using the motor vehicle shown in FIG. 21. The horizontal axis and the vertical axis are the same as those in FIG. 19.

When the forehead and the jaw of the occupant dummy FMH that have moved in the direction of an arrow D12 in FIG. 21 hit the interior member 20 almost at the same time, a compressive load first acts on the second shock absorbing parts 120 of a relatively large height in the shock absorption structure 2, and later, the compressive load acts on the first shock absorbing parts 110 of a relatively small height. As a result, a curve CU21 of the input load F₁₁ applied to the forehead of the occupant dummy FMH has a lower maximum initial load and a more moderate peak compared with the curve CU11 shown in FIG. 19.

Because the compressive load acts on the component 42, a curve CU22 of the input load F₁₂ applied to the jaw of the occupant dummy FMH rises more quickly than the curve CU21.

The input load F applied to the head of the occupant dummy FMH is approximately a total of the load F₁₁ represented by the load-displacement curve CU21 and the load F₁₂ represented by the load-displacement curve CU22. In FIG. 22, a load-displacement curve CU23 in a dashed line represents the change in the total load F. As shown in FIG. 22, because the load-displacement curve CU21 generated by the shock absorption structure 2 rises more slowly than the load-displacement curve CU22 generated by the component 42, the load applied to the head of the occupant dummy FMH can be maintained at a low level. Accordingly, the injury index of the occupant head can also be reduced by the shock absorption structure 2, and thus the shock absorbing performance can be improved in the case that the occupant hits the interior member at multiple places when a shock occurs on the motor vehicle.

Note that various modifications of the shock absorption structure having the first area R1 and the second area R2 are possible.

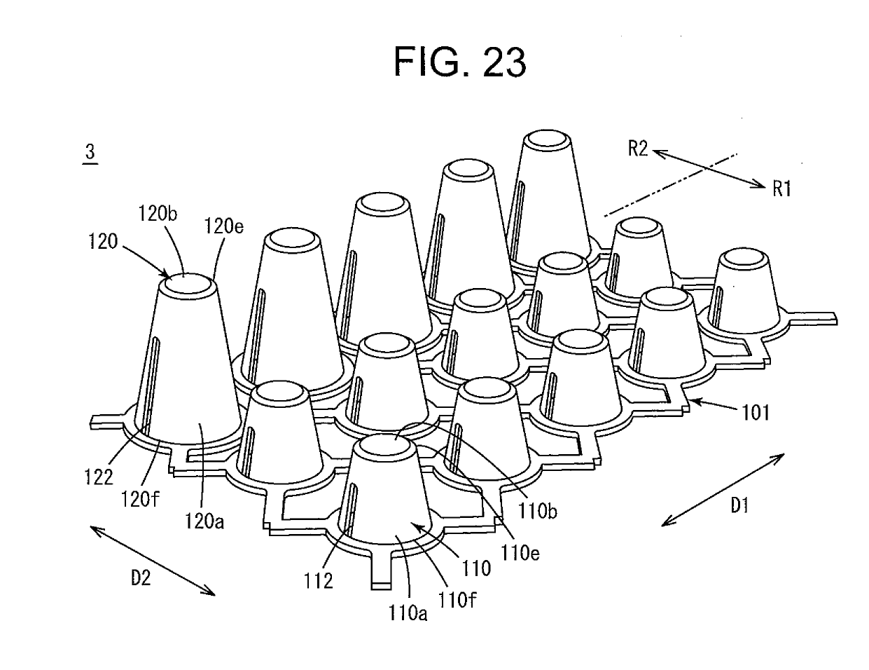

In a shock absorption structure 3 for vehicle shown in FIG. 23, the plurality of shock absorbing parts 110, 120 are divided into the first area R1 and the second area R2 at a place midway in the vehicle width direction D2. The shock absorbing parts 110 in the first area R1 may be arranged at a place facing the component such as the reinforcement, or may be arranged so as to ensure the space (SP3) between themselves and the vehicle body panel 40. The shock absorption structure 3 can also improve the shock absorbing performance in the case that the occupant hits the interior member at multiple places when a shock occurs on the motor vehicle.

### (3) Third Embodiment

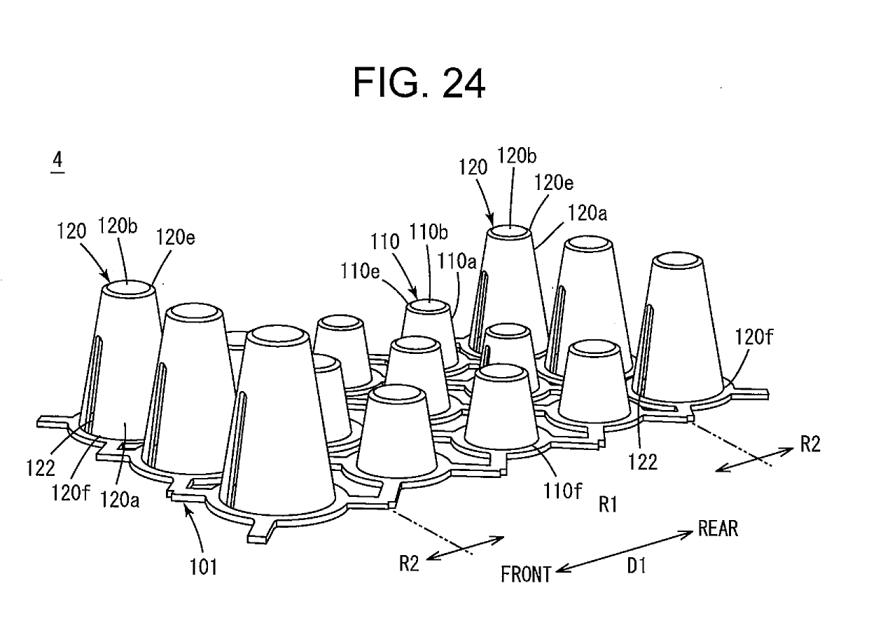

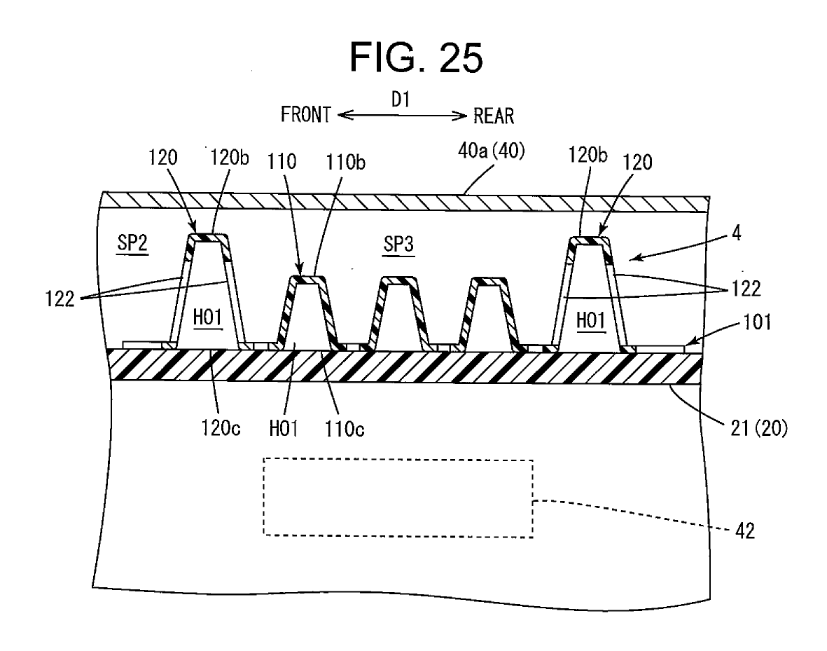

FIG. 24 is an exemplary illustration of a perspective view showing an external appearance of a shock absorption structure 4 for vehicle according to a third embodiment, and FIG. 25 is a part cross-sectional view illustrating an example of the part of the motor vehicle in a vertical section parallel to the front-rear direction.

A plurality of shock absorbing parts of the shock absorption structure 4 also include a plurality of first shock absorbing parts 110 and a plurality of second shock absorbing parts 120 having a height different from that of the first shock absorbing parts 110. Here, each of the first shock absorbing parts 110 that is cup-shaped has an open surface (lower base portion 110c) on the wide diameter side and a closed surface (upper base portion 110b) on the narrow diameter side. However, the first shock absorbing parts 110 are not formed with induction parts that induce cracks when a shock is applied. Each of the second shock absorbing parts 120 that is provided in a cup shape with a different height from that of the first shock absorbing part 110 has an open surface (lower base portion 120c) on the wide diameter side and a closed surface (upper base portion 120b) on the narrow diameter side, and also has a line-shaped induction part 122 that is formed on a side face 120a from an edge 120f on the wide diameter side to a point midway toward an edge 120e on the narrow diameter side and that induces a crack when the shock is applied. The plurality of shock absorbing parts 110, 120 of the shock absorption structure 4 are structured by combining a first area R1 composed of the plurality of first shock absorbing parts 110 and a second area R2 composed of the plurality of second shock absorbing parts 120.

A connecting part 101 connects these shock absorbing parts 110, 120 at the edges 110f, 120f on the wide diameter side.

In the shock absorption structure 4, three of the parts in the front row and three of the parts in the rearmost row serve as the second shock absorbing parts 120 having the induction parts 122, and nine of the parts interposed between sections of the second area R2 serve as the first shock absorbing parts 110 having no induction parts. A height H1 of the first shock absorbing parts 110 is smaller than a height H2 of the second shock absorbing parts 120. The difference H2-H1 between the heights can be, for example, 5 mm or more. The induction parts 122 are the same slits as those of the first and the second embodiments, and two slits are formed on each of the side faces 120a of the shock absorbing parts. The height of each of the slits 122 is preferably ( 4/7) H2 or more and ( 6/7) H2 or less. The connecting part 101 has the same structure as that of the second embodiment except that the swelled parts 101a are not provided. The connecting part 101 may obviously be provided with the swelled parts 101a. The material shown in the first embodiment may be used for forming the shock absorption structure 4. The dimensions such as the thickness of the shock absorption structure 4 are the same as those in the first embodiment.

It is preferable that the shock absorption structure 4 be used in the case in which the component 42 such as the deployment guide member provides a large stroke under the compressive force so that the bottoming occurs late, and the occupant jaw hits the interior member at a place where the component 42 is arranged while the forehead and the jaw hit the interior member almost at the same time when a shock occurs.

The shock absorption structure 4 shown in FIG. 25 is arranged in the space SP2 between the vehicle body panel 40 and the interior member 20 at a place where no components such as the reinforcement exist. The component 42 is provided at a place closer to the outside in the vehicle width direction than the shock absorbing parts 110 in the first area R1.

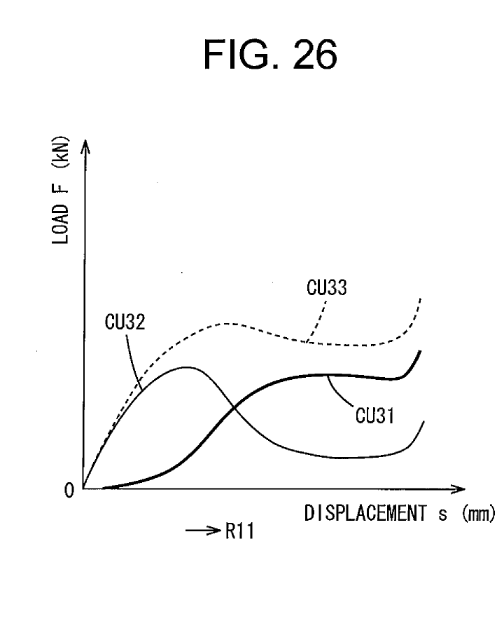

FIG. 26 illustrates an example of change in the load F applied to the head of the occupant dummy FMH when conducting the impact test using the motor vehicle shown in FIG. 25. The horizontal axis and the vertical axis are the same as those in FIG. 19.

When the forehead and the jaw of the occupant dummy FMH hit the interior member 20 almost at the same time, a compressive load acts on the component 42, and accordingly, a curve CU32 of the input load F₁₂ applied to the jaw of the occupant dummy FMH takes a form representing that the load decreases after reaching the maximum initial load. On the other hand, in the shock absorption structure 4, a compressive load first acts on the second shock absorbing parts 120 having the slits 122, and later, the compressive load acts on the first shock absorbing parts 110 having no slits.

Because the shock absorbing parts 110 of a relatively small height have no induction parts, a curve CU31 of the input load F₁₁ applied to the forehead of the occupant dummy FMH has a region in which the load is substantially constant after reaching the maximum initial load.

The input load F applied to the head of the occupant dummy FMH is approximately a total of the load F₁₁ represented by the load-displacement curve CU31 and the load F₁₂ represented by the load-displacement curve CU32. In FIG. 26, a load-displacement curve CU33 in a dashed line represents the change in the total load F. As shown in FIG. 26, when the load on the load-displacement curve CU32 generated by the component 42 decreases, the load on the load-displacement curve CU31 generated by the shock absorption structure 4 reaches the maximum initial load and then becomes substantially constant. Therefore, the load applied to the head of the occupant dummy FMH can be maintained substantially constant for a long time. Accordingly, the injury index of the occupant head can be reduced by the shock absorption structure 4, and thus the shock absorbing performance can be improved in the case that the occupant hits the interior member at multiple places when a shock occurs on the motor vehicle.

Note that, by making the second shock absorbing parts 120 of a resin material with a Charpy impact strength of 7.1 J/m²or less, a similar effect can be obtained even if the second shock absorbing parts 120 have no induction parts.

In addition, the first shock absorbing parts 110 may be made of a resin material with a Charpy impact strength a_{R1} of 7.2 J/m²or more, and the second shock absorbing parts 120 may be made of a resin material with a Charpy impact strength a_{R2} of 1.0 to 7.1 J/m²(more preferably, 1.5 to 6.0 J/m²).

### (4) Fourth Embodiment

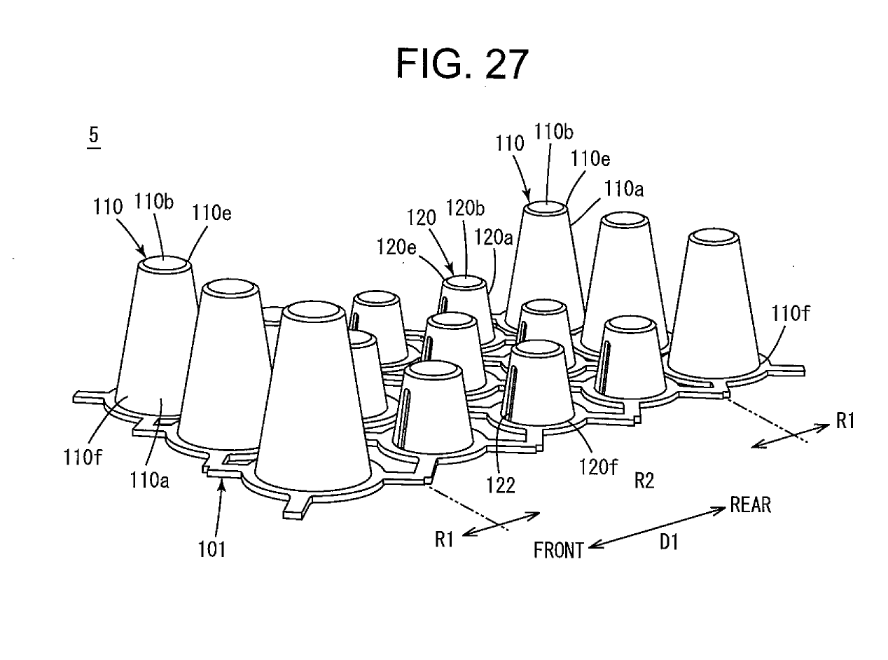

FIG. 27 is an exemplary illustration of a perspective view showing an external appearance of a shock absorption structure 5 for vehicle according to a fourth embodiment.

A plurality of shock absorbing parts of the shock absorption structure 5 also include a plurality of first shock absorbing parts 110 and a plurality of second shock absorbing parts 120 having a height different from that of the first shock absorbing parts 110. However, unlike those of the third embodiment, the first shock absorbing parts 110 having no induction parts for inducing cracks when a shock is applied have a relatively large height, and the second shock absorbing parts 120 having induction parts 122 have a relatively small height. In addition, a first area R1 composed of the plurality of first shock absorbing parts 110 is arranged in the front and the rearmost rows, and a second area R2 composed of the plurality of second shock absorbing parts 120 is arranged in a manner interposed between sections of the first area R1. Others are the same as those in the third embodiment. The installation location of the shock absorption structure 5 is also the same as that of the shock absorption structure 4 shown in FIG. 25.

It is preferable that the shock absorption structure 5 be used in the case in which the component 42 provides a small stroke under the compressive force so that the bottoming occurs early, and the occupant jaw hits the interior member at a place where the component 42 is arranged while the forehead and the jaw of the occupant hit the interior member almost at the same time when a shock occurs.

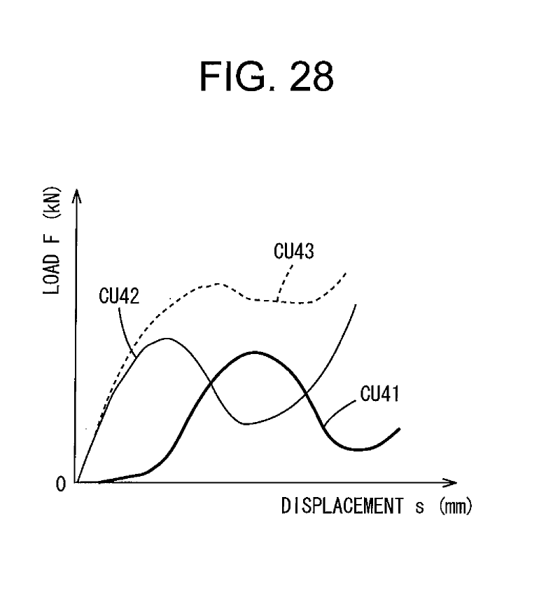

FIG. 28 illustrates an example of change in the load F applied to the head of the occupant dummy FMH when conducting the impact test using the motor vehicle installed with the shock absorption structure 5. The horizontal axis and the vertical axis are the same as those in FIG. 19.

When the forehead and the jaw of the occupant dummy FMH hit the interior member 20 almost at the same time, a compressive load acts on the component 42, and accordingly, a curve CU42 of the input load F₁₂ applied to the jaw of the occupant dummy FMH takes a form representing that the load decreases after reaching the maximum initial load and then increases to result in the bottoming state. On the other hand, in the shock absorption structure 5, a compressive load first acts on the first shock absorbing parts 110 not having the slits 122, and later, the compressive load acts on the second shock absorbing parts 120 having the slits. Because the shock absorbing parts 120 of a relatively small height have the induction parts, a curve CU41 of the input load F₁₁ applied to the forehead of the occupant dummy FMH has the reaction force descending region in which the load decreases after reaching the maximum initial load.

The input load F applied to the head of the occupant dummy FMH is approximately a total of the load F₁₁ represented by the load-displacement curve CU41 and the load F₁₂ represented by the load-displacement curve CU42. In FIG. 28, a load-displacement curve CU43 in a dashed line represents the change in the total load F. As shown in FIG. 28, when the load on the load-displacement curve CU42 generated by the component 42 decreases, the load on the load-displacement curve CU41 generated by the shock absorption structure 5 reaches the maximum initial load and then decreases along the curve CU41. Therefore, the bottoming of the combined load can be delayed. Accordingly, the injury index of the occupant head can be reduced by the shock absorption structure 5, and thus the shock absorbing performance can be improved in the case that the occupant hits the interior member at multiple places when a shock occurs on the motor vehicle.

Note that the first shock absorbing parts 110 may be made of a resin material with a Charpy impact strength a_{R1} of 7.2 J/m²or more, and the second shock absorbing parts 120 may be made of a resin material with a Charpy impact strength a_{R2} of 1.0 to 7.1 J/m² (more preferably, 1.5 to 6.0 J/m²).

### (5) Fifth Embodiment

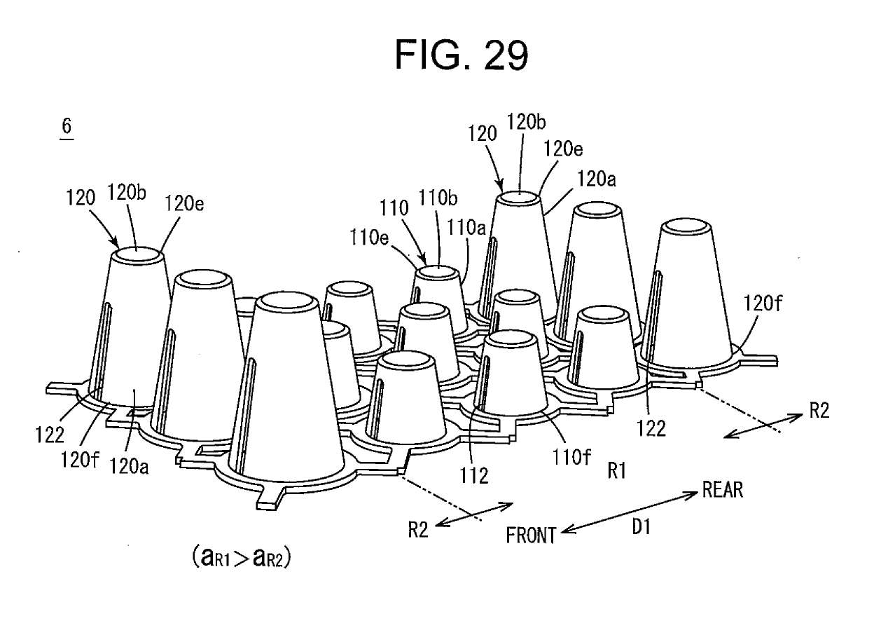

FIG. 29 is an exemplary illustration of a perspective view showing an external appearance of a shock absorption structure 6 for vehicle according to a fifth embodiment.

A plurality of shock absorbing parts of the shock absorption structure 6 also include a plurality of first shock absorbing parts 110 and a plurality of second shock absorbing parts 120 having a height different from that of the first shock absorbing parts 110. Each of the shock absorbing parts 110, 120 is provided with induction parts 112, 122 that induce cracks when a shock is applied. The induction parts 112, 122 are the same slits as those of the first embodiment, and two slits are formed on each of side faces 110a, 120a of the shock absorbing parts. Here, the first shock absorbing parts 110 are made of a resin material (including elastomer) with a Charpy impact strength a_{R1} specified in JIS K 7111-1 of 7.2 J/m²or more. The second shock absorbing parts 120 are made of a resin material (including elastomer) with a Charpy impact strength a_{R2} specified in JIS K 7111-1 of 1.0 J/m²or more (more preferably, 1.5 J/m²or more) and 7.1 J/m²or less (more preferably, 6.0 J/m²or less). Others are the same as those in the third embodiment. The installation location of the shock absorption structure 6 is also the same as that of the shock absorption structure 4 shown in FIG. 25.

Note that the shock absorption structure 6 can be integrally formed by coinjection molding.

When the impact test of the present embodiment is conducted, the load F applied to the head of the occupant dummy FMH changes as shown in FIG. 26. That is, when the forehead and the jaw of the occupant dummy FMH hit the interior member 20 almost at the same time, a compressive load first acts on the second shock absorbing parts 120 that are relatively easy to crack in the shock absorption structure 6, and later, the compressive load acts on the first shock absorbing parts 110 that are relatively difficult to crack. Because the shock absorbing parts 110 of a relatively small height are difficult to crack, the curve CU31 of the input load F₁₁ applied to the forehead of the occupant dummy FMH has the region in which the load becomes substantially constant after reaching the maximum initial load. When the load on the load-displacement curve CU32 generated by the component 42 decreases, the load on the load-displacement curve CU31 generated by the shock absorption structure 6 reaches the maximum initial load and then becomes substantially constant. Therefore, the load applied to the head of the occupant dummy FMH can be maintained substantially constant for a long time. Accordingly, the shock absorption structure 6 can improve the shock absorbing performance in the case that the occupant hits the interior member at multiple places when a shock occurs.

### (6) Sixth Embodiment

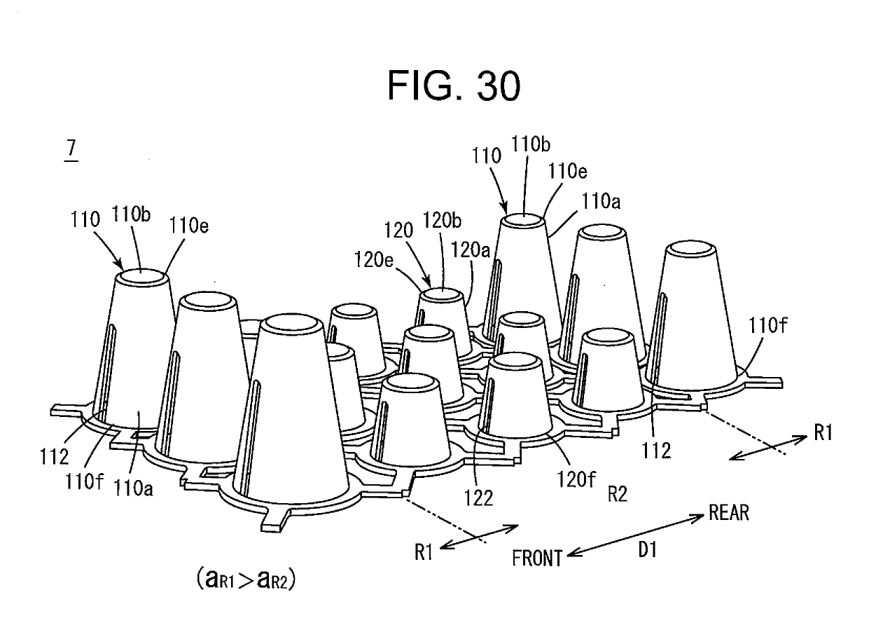

FIG. 30 is an exemplary illustration of a perspective view showing an external appearance of a shock absorption structure 7 for vehicle according to a sixth embodiment.

A plurality of shock absorbing parts of the shock absorption structure 7 also include a plurality of first shock absorbing parts 110 and a plurality of second shock absorbing parts 120 having a height different from that of the first shock absorbing parts 110. However, unlike those of the fifth embodiment, the first shock absorbing parts 110 made of a resin material with a Charpy impact strength a_{R1} of 7.2 J/m²or more have a relatively large height, and the second shock absorbing parts 120 made of a resin material with a Charpy impact strength a_{R2} of 1.0 to 7.1 J/m²(more preferably, 1.5 to 6.0 J/m²) have a relatively small height. In addition, a first area R1 composed of the plurality of first shock absorbing parts 110 is arranged in the front and the rearmost rows, and a second area R2 composed of the plurality of second shock absorbing parts 120 is arranged in a manner interposed between sections of the first area R1. Others are the same as those in the fifth embodiment. The installation location of the shock absorption structure 7 is also the same as that of the shock absorption structure 4 shown in FIG. 25.

When the impact test of the present embodiment is conducted, the load F applied to the head of the occupant dummy FMH changes as shown in FIG. 28. That is, when the forehead and the jaw of the occupant dummy FMH hit the interior member 20 almost at the same time, a compressive load first acts on the first shock absorbing parts 110 that are relatively difficult to crack in the shock absorption structure 7, and later, the compressive load acts on the second shock absorbing parts 120 that are relatively easy to crack. Because the shock absorbing parts 120 of a relatively small height are easy to crack, the curve CU41 of the input load F₁₁ applied to the forehead of the occupant dummy FMH has the reaction force descending region in which the load decreases after reaching the maximum initial load. When the load on the load-displacement curve CU42 generated by the component 42 decreases, the load on the load-displacement curve CU41 generated by the shock absorption structure 7 reaches the maximum initial load and then decreases along the curve CU41. Therefore, the bottoming of the combined load can be delayed. Accordingly, the shock absorption structure 7 can improve the shock absorbing performance in the case that the occupant hits the interior member at multiple places when a shock occurs.

Note that, because of the third to sixth embodiments, the present invention has an aspect in which a shock absorption structure is installed between a vehicle body panel and an interior member, and includes:

a plurality of cup-shaped first shock absorbing parts, each of which has an open surface on the wide diameter side and a closed surface on the narrow diameter side and is made of a resin material (including elastomer) with a Charpy impact strength specified in JIS K 7111-1 of 7.2 J/m²or more;

a plurality of second shock absorbing parts, each of which is formed in a cup shape with a different height from that of the first shock absorbing part, has an open surface on the wide diameter side and a closed surface on the narrow diameter side, and is made of a resin material (including elastomer) with a Charpy impact strength specified in JIS K 7111-1 of 1.0 J/m²or more and 7.1 J/m²or less; and

a connecting part that connects the plurality of first shock absorbing parts and the plurality of second shock absorbing parts at edges on the wide diameter sides.

When a shock is applied to the shock absorption structure, the plurality of second shock absorbing parts that are relatively easy to crack tend to crack after generating the load in the initial stage of displacement. If the plurality of second shock absorbing parts crack when the shock is applied, the load decreases after being generated in the initial stage of displacement. In addition, because the first shock absorbing parts and the second shock absorbing parts have different heights from each other, the first and the second shock absorbing parts differ in timing of the load generation in the initial stage of displacement.

As a result of the above, the shock absorbing performance can be improved in the case that the occupant hits the interior member at multiple places when a shock occurs.

### (7) Seventh Embodiment

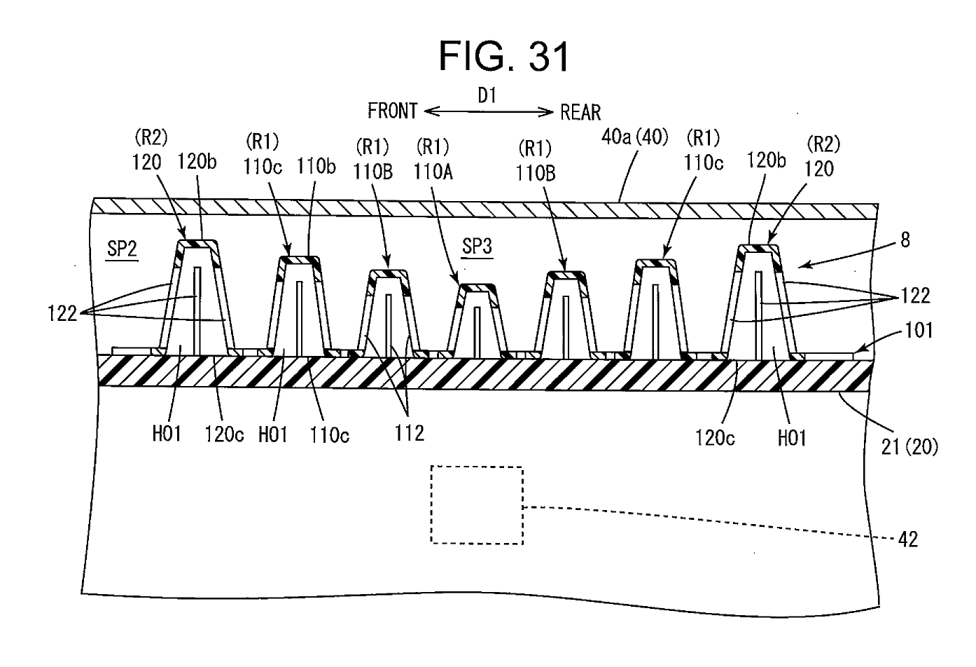

FIG. 31 illustrates, in a vertical section parallel to the front-rear direction, an example of a part of the motor vehicle equipped with a shock absorption structure 8 for vehicle according to a seventh embodiment. The vehicle is illustrated as an example in which the component 42 is attached to the pillar 40b on the back side of the pillar garnish interior material 22 at a place hit by the jaw of the occupant dummy FMH in the impact test.

In the shock absorption structure 8, three parts in the front row and three parts in the rearmost row serve as shock absorbing parts 120 of the largest height included in a second area R2, and 15 parts interposed between sections of the second area R2 serve as first shock absorbing parts 110. Here, first shock absorbing parts 110A provided at a place closer to the inside in the vehicle width direction than the component 42 have the smallest height, and the height gradually increases from the shock absorbing parts 110A through first shock absorbing parts 110B and 110C arranged toward the second shock absorbing parts 120 placed in the front and rear. Others are the same as those in the second embodiment.

When the forehead of the occupant dummy hits the interior member 20 such as the roof liner interior material 21 in the impact test, the largest deformation of the interior member occurs at the place where the forehead hits. In the shock absorption structure 8, the first shock absorbing parts 110A arranged on the back side of the interior member at the place where the forehead of the occupant dummy hits have the smallest height, and the height gradually increases from the shock absorbing parts 110A as a center through the shock absorbing parts 110B, 110C, and 120. A space SP3 between the vehicle body panel 40 and the shock absorbing parts 110A, 110B, 110C, and 120 fits the curvature of the interior member toward the outside of the vehicle that is assumed to be formed by the contact of the forehead. Therefore, when the shock is applied, the shock absorbing parts 110A, 110B, 110C, and 120 start to absorb the shock almost at the same time, and thus the times of bottoming of the shock absorbing parts become closer to each other. Accordingly, the shock absorbing performance of the shock absorption structure can be exerted as much as possible.

As a result of the above, the present invention has an aspect of a shock absorption structure installed between a vehicle body panel and an interior member, in which shock absorbing parts corresponding to an impact point that is a place where an occupant dummy first hits an interior member in an impact test have the smallest height, and the height of the shock absorbing parts gradually increases as they become distant from the impact point.

In addition, the present invention has an aspect of installing a shock absorption structure between a vehicle body panel and an interior member in a motor vehicle, in which shock absorbing parts corresponding to an impact point that is a place where an occupant dummy first hits an interior member in an impact test have the smallest height, and the height of the shock absorbing parts gradually increases as they become distant from the impact point.

Moreover, because of the second to seventh embodiments, the present invention has an aspect in which a shock absorption structure is installed between a vehicle body panel and an interior member, and includes:

a plurality of cup-shaped shock absorbing parts, each of which has an open surface on the wide diameter side and a closed surface on the narrow diameter side; and

a connecting part that connects the plurality of shock absorbing parts at the edges on the wide diameter sides, and

the plurality of shock absorbing parts includes a plurality of first shock absorbing parts and a plurality of second shock absorbing parts having a larger height than that of the first shock absorbing parts, and is structured by combining an inside area composed of the plurality of first shock absorbing parts and an outside area composed of the plurality of second shock absorbing parts provided in positions interposing the first area.

If the occupant hits the interior member when a shock occurs on the motor vehicle, the interior member curves toward the outside of the vehicle with a center on the contact point of the occupant. Here, because the first shock absorbing parts in the inside area of the shock absorption structure have a smaller height than that of the second shock absorbing parts in the outside area thereof, the time of generation of the load by the first shock absorbing parts can be made closer to the time of generation of the load by the second shock absorbing parts. As a result, the times of bottoming of the shock absorbing parts become closer to each other, thus improving the shock absorbing performance.

### (8) Modifications

There are various modifications in the present invention.

The cup shape as the shape of the shock absorbing parts means a hollow shape that has an open base on the larger area side and a closed base on the smaller area side. Therefore, the shock absorbing parts 10, 110, and 120 may have an outer shape other than a circular truncated cone shape, such as an elliptical truncated cone shape, or a polygonal truncated pyramid shape including a quadrangular truncated pyramid shape. In the case of configuring the shock absorbing parts in a polygonal truncated pyramid shape, a rectangular plane of the smaller area forms the upper base portion, and a rectangular plane of the larger area forms the lower base portion in the shock absorbing part. In the same way, the induction part is formed on a side face connecting the upper base portion and the lower base portion.

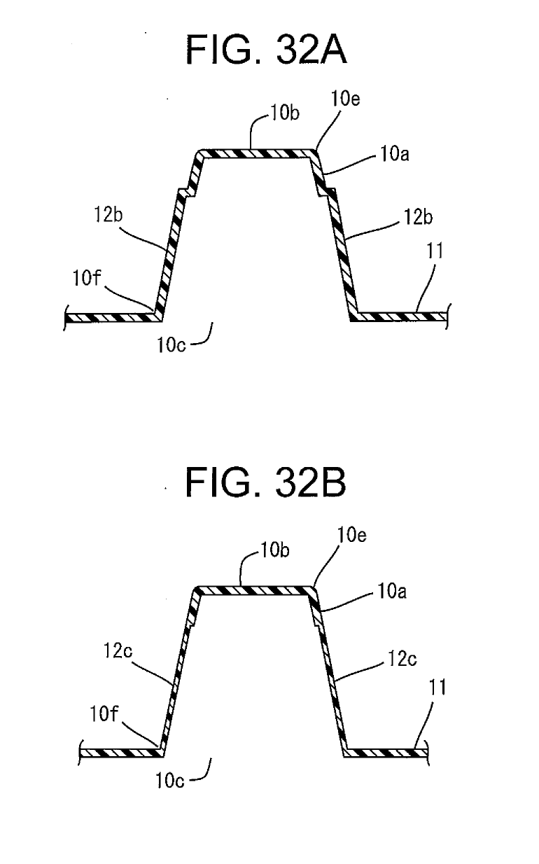

With respect to the induction parts 12, 112, and 122, the induction part 12 may be formed as a groove 12b not penetrating the side face 10a as shown in FIG. 32A, or as a thin-walled part 12c provided by making the thickness of a part of the side face 10a smaller than that of the side face 10a as shown in FIG. 32B. Note that, when forming the induction part 12 as a groove, the inner wall of the groove may be a thin-walled part having a smaller thickness than that of the side face 10a.

When installing any of the shock absorption structures 1 to 8 in the motor vehicle, the structure may be mounted to the vehicle body panel 40 so that the upper base portions of the shock absorbing parts face the interior member 20. In addition, the upper base portions of the shock absorbing parts may be attached and fixed to the interior member 20 or the vehicle body panel 40. If the upper base portions of the shock absorbing parts are also fixed, the shock absorbing parts can be suppressed from falling sideways to reduce the amount of shock absorption even when the input load is applied to the shock absorbing parts at a certain angle. Thus, the motor vehicle can be provided with a shock absorption structure that exerts a favorable shock absorbing performance regardless of the input angle of the load. Moreover, as alternatives to the adhesive bonding method, various mounting methods can be used as fixing methods for the shock absorption structure, such as clips, tackers, and threaded fasteners.

The line-shaped induction parts of the shock absorbing parts may be provided in directions different between adjoining shock absorbing parts. For example, when forming two of the slits 12a on each of the shock absorbing parts 10, the slits 12a of the adjoining shock absorbing parts 10 may be provided at angles different by 90° from each other. It is presumed that, by arranging the shock absorbing parts 10 so that the orientations of the slits 12a are not biased, the shock absorbing performance hardly vary even if the input direction of the load changes, and thus the shock absorbing performance of the shock absorption structure is improved.

The slits 12a may be formed in a molding process, or may be formed by cutting out after providing the shock absorption structure. As a result of tests, it is observed that the value of the maximum initial load tends to change as the shape of the slits 12a changes. Therefore, in order to obtain a desired shock absorbing property and a desired load-displacement curve, the value of the maximum initial load can be adjusted by changing the shape of the slits 12a without changing the material or thickness of the shock absorbing parts. As a result, the cost and the man-hour requirements for die making can also be reduced in the prototype phase, such as reduction of the die modification processes and the processes for remaking new dies.

Note that the present invention is not limited to the embodiments and the modifications described above, but can include a structure obtained by mutually replacing or changing combination of structures disclosed in the above-described embodiments and modifications, a structure obtained by mutually replacing or changing combination of structures disclosed in known art and in the above-described embodiment and modifications, and the like.

According to an aspect of the invention, it is possible to provide a shock absorption structure for vehicle that can improve the shock absorbing performance in the case that an occupant hits an interior member at multiple places when a shock occurs on a motor vehicle.

Although the invention has been described in considerable detail in language specific to structural features and or method acts, it is to be understood that the invention defined in the appended claims is not necessarily limited to the specific features or acts described. Rather, the specific features and acts are disclosed as preferred forms of implementing the claimed invention. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, proximal, distal, etc. have been used for convenience purposes only and are not intended to imply any particular fixed direction or orientation. Instead, they are used to reflect relative locations and/or directions/orientations between various portions of an object.

What is claimed is:

1. A shock absorption structure for vehicle installed between a vehicle body panel and an interior member that is closer to a passenger compartment side than the vehicle body panel, the shock absorption structure for vehicle comprising:
a plurality of cup-shaped shock absorbing parts, each of which has an open surface on a wide diameter side and a closed surface on a narrow diameter side, and also has a line-shaped induction part that is formed on a side face from an edge on the wide diameter side to a point midway toward an edge on the narrow diameter side and that induces a crack when a shock is applied; and
a connecting part that connects the plurality of shock absorbing parts at the edges on the wide diameter sides.

2. The shock absorption structure for vehicle according to claim 1, wherein the shock absorbing parts are made of a resin material (including elastomer) with a Charpy impact strength of 1.0 J/m²or more and 7.1 J/m²or less.

3. The shock absorption structure for vehicle according to claim 1, wherein the induction part is formed as a slit linearly extending on the side face of the shock absorbing part from the edge on the wide diameter side to the point midway toward the edge on the narrow diameter side.

4. The shock absorption structure for vehicle according to claim 3, wherein
a plurality of such slits are formed on the side face of the shock absorbing part; and
the height of each of the slits is ( 4/7) H or more and ( 6/7) H or less, where H is the height of the shock absorbing part measured from the connecting part.

5. The shock absorption structure for vehicle according to claim 1, wherein the plurality of shock absorbing parts include a plurality of first shock absorbing parts and a plurality of second shock absorbing parts having a height different from that of the first shock absorbing parts.

6. The shock absorption structure for vehicle according to claim 5, wherein the plurality of shock absorbing parts are structured by combining a first area composed of the plurality of first shock absorbing parts and a second area composed of the plurality of second shock absorbing parts.

7. A shock absorption structure for vehicle installed between a vehicle body panel and an interior member that is closer to a passenger compartment side than the vehicle body panel, the shock absorption structure for vehicle comprising:
a plurality of cup-shaped first shock absorbing parts, each of which has an open surface on a wide diameter side and a closed surface on a narrow diameter side;
a plurality of second shock absorbing parts, each of which is formed in a cup shape with a different height from that of the first shock absorbing part, has an open surface on the wide diameter side and a closed surface on the narrow diameter side, and also has a line-shaped induction part that is formed on a side face from an edge on the wide diameter side to a point midway toward an edge on the narrow diameter side and that induces a crack when a shock is applied; and
a connecting part that connects the plurality of first shock absorbing parts and the plurality of second shock absorbing parts at the edges on the wide diameter sides.

8. The shock absorption structure for vehicle according to claim 7, wherein
the first shock absorbing parts are made of a resin material (including elastomer) with a Charpy impact strength of 7.2 J/m²or more; and
the second shock absorbing parts are made of a resin material (including elastomer) with a Charpy impact strength of 1.0 J/m²or more and 7.1 J/m²or less.
